(19) United States
(12) Patent Application Publication
(10) Pub. No.: US 2005/0212787 A1
(43) Pub. Date: Sep. 29, 2005

(54) Display apparatus that controls luminance irregularity and gradation irregularity, and method for controlling said display apparatus

(75) Inventors: Yukihiro Noguchi, Motosu-Gun (JP); Satoru Sekine, Anpachi-Gun (JP); Kouiti Yamada, Hashima-gun (JP); Shoichiro Matsumoto, Oogaki-City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/084,134

(22) Filed: Mar. 21, 2005

(30) Foreign Application Priority Data
Mar. 24, 2004 (JP) 2004-088038
Mar. 25, 2004 (JP) 2004-090219
Mar. 26, 2004 (JP) 2004-092052
Mar. 11, 2005 (JP) 2005-069505

(51) Int. Cl. G09G 5/00

(52) U.S. Cl. 345/204

(57) ABSTRACT

In an active matrix display apparatus, the drive transistor to drive an OLED self-corrects the operation timing of the drive transistor. A correction transistor controls on and off of the self-correction. The drive circuit self-corrects the operation of the drive transistor by generating a luminance signal which is corrected based on a predetermined signal delivered temporarily and an operation threshold value. The current flowing to the OLED is controlled by gradually changing the voltage of luminance signal from a ramp signal line. After the luminance signal for one frame is inputted to each pixel, the same luminance signal for one frame is inputted to the each pixel in a reversed scanning direction. One frame period is divided into a plurality of subframe periods and the data control circuit inputs respectively the same luminance signal to each pixel in the plurality of subframe periods.

### BACKGROUND OF THE INVENTION

1. Field of the Invention

The present invention relates to display apparatus, and it particularly relates to a technology for display apparatus using an organic EL.

2. Description of the Related Art

Organic electroluminescent (hereinafter referred to as “organic EL”) display apparatuses are attracting increasing attention as a new type of flat-panel display apparatuses. It is believed that the organic EL display apparatus will soon replace the currently widespread liquid crystal display devices. As a result, the organic EL display apparatus is today amidst an intense development competition toward practical application and mass production.

There are two drive systems for the organic EL display apparatus, namely, the passive matrix drive system, in which light is emitted by time division from the pixel held between a scanning electrode and a data electrode at the position where they intersect each other, and the active matrix drive system, in which light emission from each pixel is maintained for one frame period. Problems with the active matrix drive system include the possibility of luminance irregularity that may occur due to variation in the characteristics of a drive transistor in each pixel. This kind of luminance irregularity can be effectively eliminated by correcting the luminance signal in response to the characteristics of the drive transistor as disclosed in Japanese Laid-Open Patent Application 2003-288055. On the other hand, when a point sequential drive method is used, there is a possibility of gradation irregularity occurring in the left and right display due to the length of correction period. And a known technique to eliminate the gradation irregularity occurring in the left and right display uses a liquid crystal display device that provides display using a different scanning direction for each frame as disclosed in Japanese Laid-Open Patent Application 2001-166277.

As for the drive system for an organic EL display apparatus, there are roughly two types, namely, the analog drive system and the digital drive system. In an analog drive system, a current corresponding to the magnitude of data voltage is supplied to each organic EL element and light is emitted at a luminance corresponding to the data voltage. There are a variety of methods proposed for the digital drive system. In a time gradation system, for instance, multiple gradations are realized by supplying a pulse current having a duty ratio corresponding to data voltage to each organic EL element and causing light emission for a period corresponding to the data voltage as disclosed in Japanese Laid-Open Patent Application 2003-5709.

Of such time gradation systems, a subfield drive system is such that a field (frame) period, which is a display cycle of a screen, is divided into a plurality of subfield (frame) periods and the organic EL elements are each lit up for a period corresponding to a supplied data voltage by controlling the on and off of emission in each subfield period. In so doing, the same amount of current is supplied to the organic EL elements, which emit light with the same luminance, but the gradation of their emission is produced by the length of their emission time. The emission period of each subfield has a length of 2 to the nth power (n=0, 1, 2, . . . , N-1). For example, 256 gradations are produced by the on and off of the emission period set at lengths of 1, 2, 4, 8, 16, 32, 64 and 128.

With a display apparatus disclosed in JPA laid open 2003-288055, correction of a luminance signal is accomplished by setting the gate voltage of a transistor at the level of an operation threshold value at which the transistor just barely turns on. However, the gate voltage of a transistor, if it is near the operation threshold value, produces an extremely high impedance. This results in a lapse of time, which cannot be ignored in operation, and renders control very complex until the gate voltage is set at the level of the operation threshold value.

With a display apparatus disclosed in JPA laid open 2001-166277, the status of gradation irregularity that has occurred in a frame gets inverted in a subsequent frame. Hence, when an image with little change in luminance between frames is to be displayed, the gradation irregularity as a whole may not be so conspicuous for a certain group of pixels having developed the gradation irregularity in the previous frame, because the gradation irregularity for the same pixels will be unlikely to occur in the next frame. However, when an image with a considerable change in luminance between frames is to be displayed, there will be as an inevitable consequence a significant drop in image quality due to gradation irregularity, which may not be fully rectified in the next frame where there may be much change in luminance for the same pixels as have developed gradation irregularity in the previous frame.

With a display apparatus disclosed in JPA laid open 2003-5709, a through current flows in the inverter circuit from the luminance signal write period to the emission period. This through current, which is of a significant magnitude in relation to the drive current that flows to the organic EL elements, can be a cause for increased power consumption.

### RELATED ART LIST

JPA laid open 2003-288055
JPA laid open 2001-166277
JPA laid open 2003-5709

### SUMMARY OF THE INVENTION

The present invention has been made in view of the foregoing circumstances, and an objective thereof is to provide a display apparatus capable of effectively reducing the effects of luminance irregularity or gradation irregularity.

A preferred mode of carrying out the present invention relates to a display apparatus. This apparatus includes a plurality of pixels arranged in a matrix. Each of the plurality of pixels includes: an optical element of current-driven type; a drive circuit of non-complementing type which drives the optical element based on a luminance signal and self-corrects a drive operation thereof; a correction circuit which controls on and off of the self-correction of the drive circuit; and a holding circuit which holds the luminance signal used in the drive operation. The drive circuit generates a luminance signal which is corrected based on a predetermined signal delivered temporarily and an operation threshold value of the drive circuit, and self-corrects the drive operation by driving the optical element based on the corrected luminance signal.

As the optical element, an organic light-emitting diode (OLED) can be assumed here but the optical element is not limited thereto. As the drive circuit and the correction circuit, a metal oxide-semiconductor (MOS) transistor or a thin film transistor (TFT) can be assumed here but they are not limited thereto. The “operation threshold value of the drive circuit” may be a threshold voltage of a transistor. The “drive circuit of non-complementing type” may be, for example, a drive circuit excluding that of such a type, for example an inverter, that the through current flows. Thus, while the “drive circuit of non-complementing type” is performing the self-correction, the signal line of a signal used for the correction is not connected at least directly to ground potential, so that the through current does not flow. The holding circuit may contain a capacitance.

By employing the display apparatus according to the above mode of carrying out the present invention, the self-correction is performed by a drive circuit of non-complementing type, based on the characteristics of said drive circuit. Hence, the optical element can be driven irrespective of variation in characteristics of the drive circuit while the through current is prevented during the period of correction.

Another preferred mode of carrying out the present invention relates also to a display apparatus. This apparatus includes a plurality of pixels arranged in a matrix. Each of the plurality of pixels includes: an optical element of current-driven type; a drive circuit of which drives the optical element based on a luminance signal and self-corrects a drive operation thereof; a power supply circuit, connected with the drive circuit, which controls power supply to the optical element via the drive circuit; a write circuit, connected with the drive circuit, which controls input of the luminance signal to the pixel; a correction circuit which connects and shuts off a path through which a signal that has flowed to the drive circuit is inputted to the drive circuit for performing self-correction; a holding capacitance which holds a signal inputted to the drive circuit; a control circuit which controls drive of the optical element by the drive circuit, by gradually decreasing or gradually increasing voltage of the signal held by the holding capacitance; and a reset circuit which connects and shuts off a path of drive current to the optical element. The drive circuit generates a luminance signal which is corrected based on a luminance signal delivered temporarily through the write circuit and an operation threshold value of the derive circuit, and self-corrects the drive operation by driving the optical element based on the thus corrected luminance signal; the power supply circuit shuts off power to the optical element via the drive circuit during a period of the self-correction; and the reset circuit shuts off the path of drive current to the optical element during a period of the self-correction.

A MOS transistor or a TFT can be assumed as the drive circuit, power supply circuit, write circuit, correction circuit and reset circuit. However, these circuits are not limited to the MOS transistor or TFT.

By employing the display apparatus according to the above mode of carrying out the present invention, the drive circuit self-corrects the luminance signal based on the characteristics of said drive circuit and drives the optical element independently of variation in the characteristics of said drive circuit, and the through current does not occur during the period of correction.

Still another preferred mode of carrying out the present invention relates to a display apparatus controlling method. This method includes: flowing a predetermined signal to a drive circuit of non-complementing type which drives an optical element of current-driven type; generating a luminance signal by correcting the predetermined signal flowing through the drive circuit with an operation threshold value of the drive circuit; setting the corrected luminance signal in the drive circuit and holding the thus set corrected luminance signal; shutting off flow of the predetermined signal to the drive circuit; and supplying drive current to the optical element by gradually decreasing or gradually increasing voltage of the luminance signal held in the setting and holding.

By employing this method according to the above mode of carrying out the present invention, the self-correction is performed by a drive circuit of non-complementing type based on the characteristics of the drive circuit, so that the through current does not occur during the period of correction. Moreover, the optical element can be driven independently of variation in the characteristics of the drive circuit.

Still another preferred mode of carrying out the present invention relates to a display apparatus. This display apparatus, which is of active matrix type, includes: a plurality of pixels arranged in a matrix; and a data control circuit which inputs a luminance signal to each of the plurality of pixels so that one frame is displayed a plurality of times in different scanning directions.

By employing the display apparatus according to this mode of carrying out the present invention, one frame is displayed a plurality of times in different scanning directions, so that even if image degradation occurs in a scanning, the degradation is compensated for by the repeated scanning. In particular, even with moving pictures whose brightness changes fast, the image degradation can be more securely compensated for by an amount displayed a plurality of times in one frame.

Still another preferred mode of carrying out the present invention relates also to a display apparatus. This apparatus, which is of active matrix type, includes: a plurality of pixels arranged in a matrix; a selection control circuit which selects a pixel line to which a luminance signal is to be inputted among the plurality of pixels; and a data control circuit which sequentially inputs the luminance signal for each pixel contained in the pixel line selected by the selection control circuit. The data control circuit is such that after a luminance signal for one frame is inputted to each pixel, the same luminance signal for one frame is again inputted to the each pixel in a reversed scanning direction, in order for the luminance signal for one frame to be inputted a plurality of times for the each pixel.

In a case when a relatively longer time is required for writing or compensating for a luminance signal in each pixel included in a display apparatus which uses a system of a point sequential drive for writing the luminance signal or other, the image degradation may be caused due to differences in the input timing of the luminance signals in the respective pixels. However, by employing the structure according to this mode of carrying out the present invention, one frame is displayed a plurality of times in different scanning directions. Hence, even if the image degradation occurs in a scanning, the degradation is compensated for by the repeated scanning. In particular, even with moving pictures whose brightness changes fast, the image degradation can be more securely compensated for by an amount displayed a plurality of times in one frame.

Still another preferred mode of carrying out the present invention relates also to a display apparatus. This apparatus includes: a plurality of pixels arranged in a matrix; a selection control circuit which selects a pixel line to which a luminance signal is to be inputted among the plurality of pixels; and a data control circuit which sequentially inputs the luminance signal for each pixel contained in the pixel line selected by the selection control circuit. Each of the plurality of pixels includes: an optical element of current-driven type; a drive circuit which drives the optical element based on a luminance signal which has been corrected according to an operating characteristic; and a write circuit which controls write of the luminance signal. The data control circuit is such that after a luminance signal for one frame is inputted to each pixel, the same luminance signal for one frame is again inputted to the each pixel in a reversed scanning direction, in order for the luminance signal for one frame to be inputted a plurality of times for the each pixel.

As the optical element, an organic light-emitting diode (OLED) can be assumed here but the optical element is not limited thereto. As the drive circuit and the write circuit, a metal oxide semiconductor (MOS) transistor or a thin film transistor (TFT) can be assumed here but they are not limited thereto. The “operating characteristic of a drive circuit” may be, for example, a threshold voltage of the drive transistor.

By employing the display apparatus according to this mode of carrying out the present invention, even if the image degradation occurs in a scanning, the degradation is compensated for by the repeated scanning, by an amount in which one frame is displayed a plurality of times in different scanning directions.

Still another preferred mode of carrying out the present invention relates to a display apparatus controlling method. This method includes: first selecting sequentially a pixel line, to which a luminance signal is to be inputted, among a plurality of pixels arranged in a matrix; inputting sequentially a luminance signal of one frame in a predetermined scanning direction for each pixel contained in the pixel line selected by the first selecting, every time the pixel line is selected in the first selecting; correcting the inputted luminance signal based on an operating characteristic of a drive circuit included in the pixel; second selecting sequentially the pixel line from the beginning, after completing the first selecting for all pixel lines contained in the plurality of pixels; inputting sequentially the same luminance signal as the luminance signal of one frame in a scanning direction opposite to the predetermined scanning direction for each pixel contained in the pixel line selected by the second selecting, every time the pixel line is selected in the second selecting; and correcting the inputted luminance signal based on an operating characteristic of a drive circuit included in the pixel.

By employing this method according to this mode of carrying out the present invention, one frame is displayed a plurality of times in different scanning directions. Thus, even if the gradation irregularity due to the differences in input timing of the luminance signals is caused as a result of correction based on the operating characteristic of the drive circuit in a certain scanning, the gradation irregularity is compensated for by the repeated scanning. Hence, even with moving pictures whose brightness changes fast, the image degradation can be more securely compensated for.

Still another preferred mode of carrying out the present invention relates to a display apparatus. This apparatus, using a time gradation system, includes: an optical element of current-driven type; a drive circuit which drives the optical element; and a time control circuit which controls drive timing by the drive circuit according to a luminance signal inputted. The time control circuit controls emission start timing according to the luminance signal in a control of a first emission period which is any emission period among a plurality of emission periods for one luminance signal, and controls emission stop timing according to the luminance signal in a control of a second emission period which is any emission period different from the first emission period thereamong.

As the optical element, an organic light-emitting diode (OLED) can be assumed here but the optical element is not limited thereto. As the drive circuit and the time control circuit, a metal oxide semiconductor (MOS) transistor or a thin film transistor (TFT) can be assumed here but they are not limited thereto. “A plurality of emission periods” may be a plurality of sub-emission-periods which are formed by dividing one frame or may be a separate emission period contained in each of a plurality of frames.

By employing the display apparatus according to this mode of carrying out the present invention, the emission start and the emission stop are controlled based on a luminance signal at each of the plurality of emission periods. Thus, even in a case when the variation in characteristics of an internal circuit affects controlling the emission period, any difference can be offset by any other difference and the sum of the emission periods can be kept constant.

The time control circuit may cancel a difference caused in the emission start timing according to the luminance signal in the control of a first emission period and based on variation in an operation threshold of the time control circuit, by a difference caused in the emission stop timing according to the luminance signal in the control of a second emission period and based on variation in an operation threshold of the time control circuit. Thereby, the emission period can be kept constant irrespective of the variation in the characteristics of the time control circuit and the luminance irregularity due to the variation in the characteristics thereof can be avoided.

The apparatus may further include a drive control circuit which turns the drive circuit on in the first emission period when the time control circuit is turned on and which turns the drive circuit off in the second emission period when the time control circuit is turned on.

Still another preferred mode of carrying out the present invention relates also to a display apparatus. This apparatus includes: a time control transistor which controls drive timing of an optical element according to a luminance signal inputted; and a circuit which gradually increases or gradually decreases source voltage or drain voltage of the time control transistor. The time control transistor controls emission start timing of the optical element in a control of a first emission period which is any emission period among a plurality of emission periods for one luminance signal, by gradually increasing or gradually decreasing the source voltage or drain voltage thereof whereas the time control transistor controls emission stop timing of the optical element in a control of a second emission period which is any emission period different from the first emission period thereamong, by gradually increasing or gradually decreasing the source voltage or drain voltage thereof.

By employing the display apparatus according to this mode of carrying out the present invention, the emission start and the emission stop are controlled based on a luminance signal at each of the plurality of emission periods. Thus, even in a case when the variation in characteristics of an internal circuit affects controlling the emission period, any difference can be offset by any other difference and the sum of the emission periods can be kept constant.

Still another preferred mode of carrying out the present invention relates to a display apparatus controlling method. This method includes: inputting a luminance signal indicative of emission start timing of an optical element in a control of a first emission period which is any emission period among a plurality of emission periods for one luminance signal; increasing gradually or decreasing gradually voltage of the luminance signal indicative of the emission start timing; turning a drive circuit on and starting emission of the optical element when the time control circuit which controls drive timing by the drive circuit is turned on by the increasing gradually or decreasing gradually voltage of the luminance signal; stopping the emission of the optical element with a predetermined timing; inputting a luminance signal indicative of emission stop timing of the optical element in a control of a second emission period which is any emission period different from the first emission period among the plurality of emission periods; starting emission of the optical element with a predetermined timing; increasing gradually or decreasing gradually voltage of the luminance signal indicative of the emission stop timing; and turning the drive circuit off and stopping the emission of the optical element when the time control circuit is turned on by the increasing gradually or decreasing gradually voltage of the luminance signal.

By employing the display apparatus according to this mode of carrying out the present invention, the emission start and the emission stop are controlled based on a luminance signal at each of the plurality of emission periods. Thus, even in a case when the variation in characteristics of an internal circuit affects controlling the emission period, any difference can be offset by any other difference and the sum of the emission periods can be kept constant.

It is to be noted that any arbitrary combination of the above-described components and expressions mutually replaced by among a method, an apparatus, a system and so forth are all effective as and encompassed by the modes of carrying out the present invention.

### BRIEF DESCRIPTION OF THE DRAWINGS

FIG. 1 illustrates a basic structure of a pixel included in a display apparatus according to a first embodiment of the present invention.

FIG. 2 illustrates an arrangement relationship of a plurality of pixels included in the display apparatus of the first embodiment.

FIG. 3 is a timing chart showing a state change relationship among signals to be inputted to a first pixel in the first embodiment.

FIG. 4 illustrates a basic structure of a pixel included in a display apparatus according to a second embodiment of the present invention.

FIG. 5 illustrates a basic structure of a pixel region and its periphery included in a display apparatus according to a third embodiment of the present invention.

FIG. 6 illustrates a detailed structure of a data control circuit in the third embodiment.

FIG. 7 schematically illustrates detailed drive timing in one frame period in the third embodiment.

FIG. 8 is a timing chart showing a state change relationship among signals inputted to a first pixel in the third embodiment.

FIG. 9A schematically illustrate the display status of each pixel in a first subframe period according to the third embodiment.

FIG. 9B schematically illustrate the display status of each pixel in a second subframe period according to the third embodiment.

FIG. 10A schematically illustrate the display status of each pixel in a first subframe period according to a fourth embodiment.

FIG. 10B schematically illustrate the display status of each pixel in a second subframe period according to a fourth embodiment.

FIG. 11 illustrates a basic structure of a pixel included in a display apparatus according to a fifth embodiment of the present invention.

FIG. 12 is a timing chart showing a state change relationship among control signals inputted to a display apparatus according to the fifth embodiment.

FIG. 13 illustrates a basic structure of a pixel included in a display apparatus according to a sixth embodiment of the present invention.

FIG. 14 is a timing chart showing a state change relationship among control signals inputted to a display apparatus according to the sixth embodiment.

FIG. 15 illustrates a basic structure of a pixel included in a display apparatus according to a seventh embodiment of the present invention.

FIG. 16 is a timing chart showing a state change relationship among control signals inputted to a display apparatus according to a seventh embodiment of the present invention.

FIG. 17 illustrates a basic structure of a pixel included in a display apparatus according to an eighth embodiment of the present invention.

FIG. 18 is a timing chart showing a state change relationship among control signals inputted to a display apparatus according to the eighth embodiment.

FIG. 19 illustrates a basic structure of a pixel included in a display apparatus according to a ninth embodiment of the present invention.

FIG. 20 is a timing chart showing a state change relationship among control signals inputted to a display apparatus according to the ninth embodiment.

FIG. 21 illustrates a basic structure of a pixel included in a display apparatus according to a tenth embodiment of the present invention.

FIG. 22 is a timing chart showing a state change relationship among control signals inputted to a display apparatus according to the tenth embodiment.

FIG. 23 illustrates a basic structure of a pixel included in a display apparatus according to an eleventh embodiment of the present invention.

FIG. 24 is a timing chart showing a state change relationship among control signals inputted to a display apparatus according to the eleventh embodiment.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

### First Embodiment

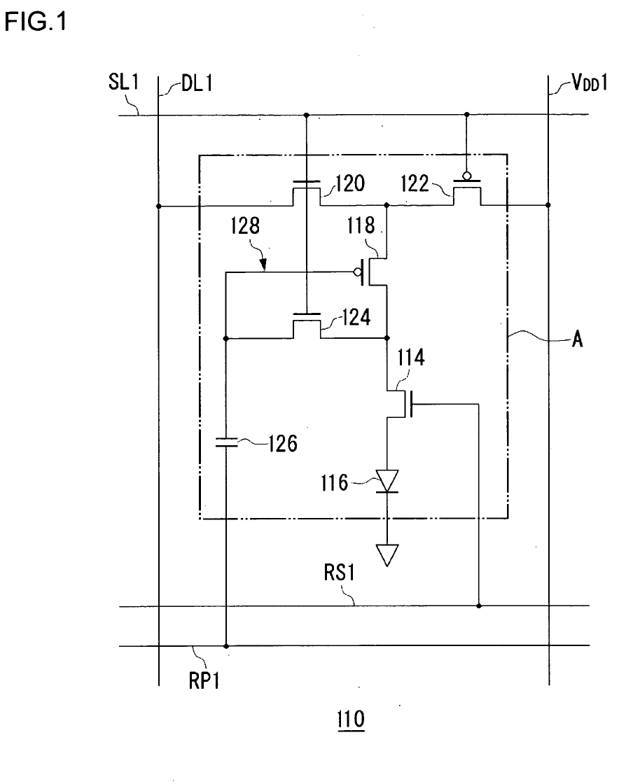

FIG. 1 illustrates a basic structure of a pixel included in a display apparatus according to a first embodiment of the present invention. In a display apparatus 110, a first pixel A includes an organic light-emitting diode (hereinafter referred to as “OLED”) 116, a reset transistor 114, a drive transistor 118, a write transistor 120, a power supply transistor 122, a correction transistor 124 and a holding capacitance 126. The OLED 116, which is a current-driven-type optical element, emits light at an intensity corresponding to a current value when a drive current flows. In the present embodiment, however, the value of the drive current is approximately constant, and therefore the gradation is produced by the length of emission period of each pixel.

The drive transistor 118 and the power supply transistor 122 are each a p-channel MOS transistor. The reset transistor 114, the write transistor 120 and the correction transistor 124 are each an n-channel MOS transistor. The drive transistor 118 functions as a drive circuit for driving the light emission of the OLED 116. The reset transistor 114 functions as a reset circuit that switches on (connection) and off (shutoff) the signal path for the current driving the OLED 116.

The write transistor 120 has a drain electrode thereof connected to a first data signal line DL1 and a source electrode thereof connected to a drain electrode of the power supply transistor 122 and a source electrode of the drive transistor 118. A gate electrode of the write transistor 120 is connected to a first selection signal line SL1. The power supply transistor 122 has a source electrode thereof connected to a first power supply line VDD1 and a gate electrode thereof connected to the first selection signal line SL1. A drain electrode of the drive transistor 118 is connected to a source electrode of the correction transistor 124 and a drain electrode of the reset transistor 114. A drain electrode of the correction transistor 124 is connected to a gate electrode of the drive transistor 118 and one end of the holding capacitance 126. The other end of the holding capacitance 126 is connected to a first ramp signal line RP1. A gate electrode of the correction transistor 124 is connected to the first selection signal line SL1. The reset transistor 114 has a source electrode thereof connected to an anode of the OLED 116 and a gate electrode thereof connected to a first reset line RS1. The holding capacitance 126 holds a luminance signal set at the gate electrode of the drive transistor 118.

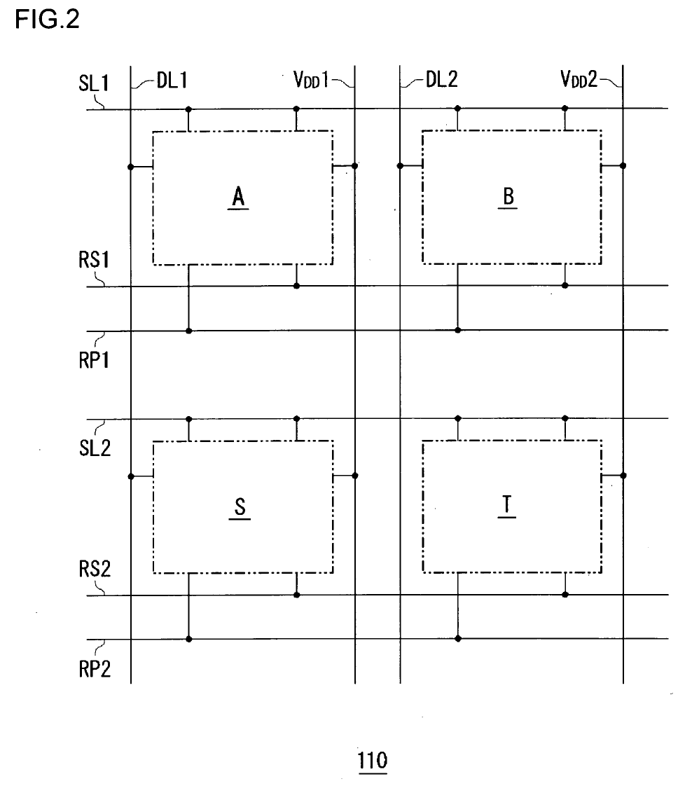

FIG. 2 illustrates an arrangement relationship of a plurality of pixels included in a display apparatus. In a display apparatus 110, a plurality of pixels are arranged in a matrix. For example, a plurality of pixels, such as a first pixel A and a second pixel B, are arranged horizontally in the first row, and a plurality of pixels, such as an nth pixel S (n being a natural number) and an (n+1)th pixel T, are arranged horizontally in the second row. The first pixel A is connected to a first selection signal line SL1, a first data signal line DL1, a first power supply line VDD1, a first reset line RS1 and a first ramp signal line RP1. The second pixel B is connected to a first selection signal line SL1, a second data signal line DL2, a second power supply line VDD2, a first reset line RS1 and a first ramp signal line RP1. The nth pixel S is connected to a second selection signal line SL2, the first data signal line DL1, the first power supply line VDD1, a second reset line RS2 and a second ramp signal line RP2. The (n+1)th pixel T is connected to the second selection signal line SL2, the second data signal line DL2, the second power supply line VDD2, the second reset line RS2 and the second ramp signal line RP2. Each pixel, including the second pixel B, the nth pixel S and the (n+1)th pixel T, is structured the same way as the first pixel A.

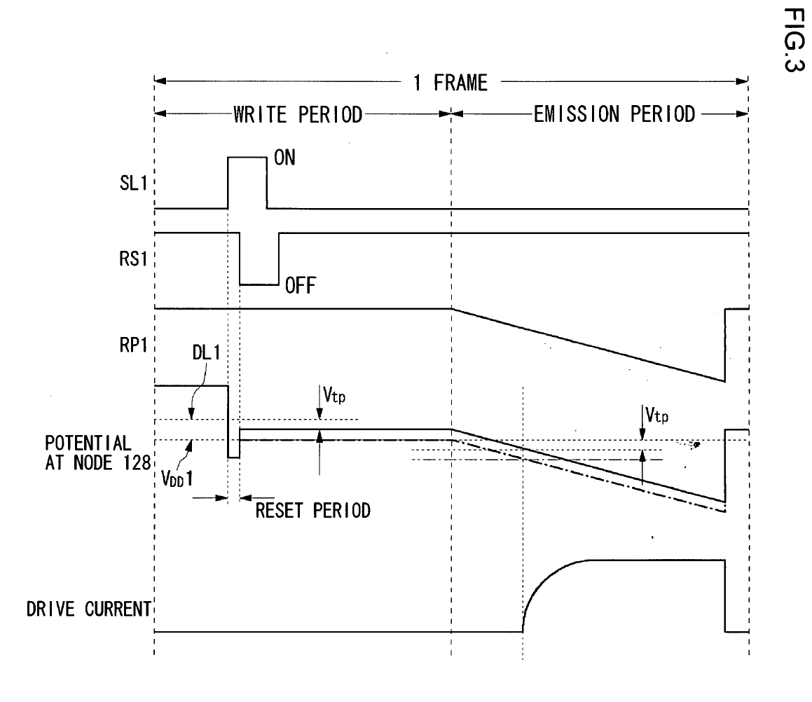

FIG. 3 is a timing chart showing a state change relationship among the signals to be inputted to the first pixel A. As shown in FIG. 3, one horizontal line selection period is divided into two parts, the first half serving as a luminance signal write period and the second half as an emission period in the control of each pixel. In the write period, when a selection signal inputted from the first selection signal line SL1 goes high, the write transistor 120 and the correction transistor 124 are turned on and the power supply transistor 122 is turned off. At this time, a reset signal inputted from the first reset line RS1 is high, and the reset transistor 114 is on. Accordingly, a node 128 is in connection with the OLED 116, so that a reset is performed with the potential at the node 128 dropping. As the reset signal goes low and the reset transistor 114 turns off, a reset period for the node 128 is completed.

At the end of the reset period, the potential at the node 128 is sufficiently lower than that of a luminance signal inputted from the first data signal line DL1, so that the drive transistor 118 is turned on. A luminance signal having flowed through the drive transistor 118 is inputted to the node 128 and written to the gate electrode of the drive transistor 118. Now, with the drain electrode and the gate electrode of the drive transistor 118 short-circuited, the potential at the node 128 drops gradually and gets turned off when it reaches a level lower than a luminance signal voltage Vdata by a threshold voltage Vtp of the drive transistor 118. That is, the value of Vdata-Vtp is set for the node 128. Even when the first selection signal line SL1 goes low and the write transistor 120 and the correction transistor 124 turn off, the value for the node 128 is maintained by the holding capacitance 126.

When the first selection signal line SL1 goes low, the power supply transistor 122 is turned on. When the first reset line RS1 goes high, the reset transistor 114 is also turned on. At this time, since the power supply voltage supplied from the first power supply line VDD1 is set lower than the low-level voltage of a luminance signal inputted from the first data signal line DL1 and the potential for the node 128 is Vdata-Vtp, the drive transistor 118 remains off. Hence, a current does not flow to the drive transistor 118, and thus the OLED 116 remains off.

In an emission period, a ramp signal is inputted from the first ramp signal line RP1 to the holding capacitance 126. Since the potential of a ramp signal is fixed at a high level during the write period and lowers gradually in the emission period, the potential at the node 128 also lowers gradually from Vdata-Vtp as a result of coupling with the holding capacitance 126. Thus, in a manner as described above, each pixel incorporated in a display apparatus 110 is controlled.

Of the plurality of pixels included in a display apparatus 110, the pixels have their respective OLEDs 116 emit light sequentially as the potential at the node 128 reaches a value smaller by Vtp than the power supply potential and a current flows to the drive transistor 118 of each of the pixels. The potential of a ramp signal returns to a high level, which is the initial value, immediately before the end of an emission period, so that the potential at the node 128 also returns to Vdata-Vtp, which is the initial value, thus putting the OLEDs 116 of all the pixels included in the display apparatus 110 in a light non-emissive state. In this manner, a multiple-gradation display is realized by modulating the light emission time of each pixel based on the voltage of a luminance signal.

As described above, Vdata-Vtp, which is a value of the voltage of a luminance signal corrected by the threshold voltage of the drive transistor 118, is written to the gate electrode of the drive transistor 118, and the start timing for light emission is determined by a ramp signal based on the potential. In this case, the OLED 116 can be turned on independently of the threshold voltage of the drive transistor 118, so that there occurs no variation in display among the pixels. Also, no current flows to the OLED 116 during the write period, when the drive transistor 118 is off. Moreover, no through current flows either because the drive transistor 118 is a non-complementary drive circuit. As a result, while power consumption by the display apparatus 110 as a whole is held low, the optical elements can be driven independently of any variation in characteristics of the drive circuit and thus luminance irregularity of the display apparatus can be avoided.

### Second Embodiment

A display apparatus according to a second embodiment of the present invention differs from a display apparatus according to the first embodiment in the structure or arrangement of transistors included therein. Also, the structure of signal lines and the polarity of part of the signal lines differ from those of the first embodiment. The following description therefore will center on the differences and omit the common features as appropriate.

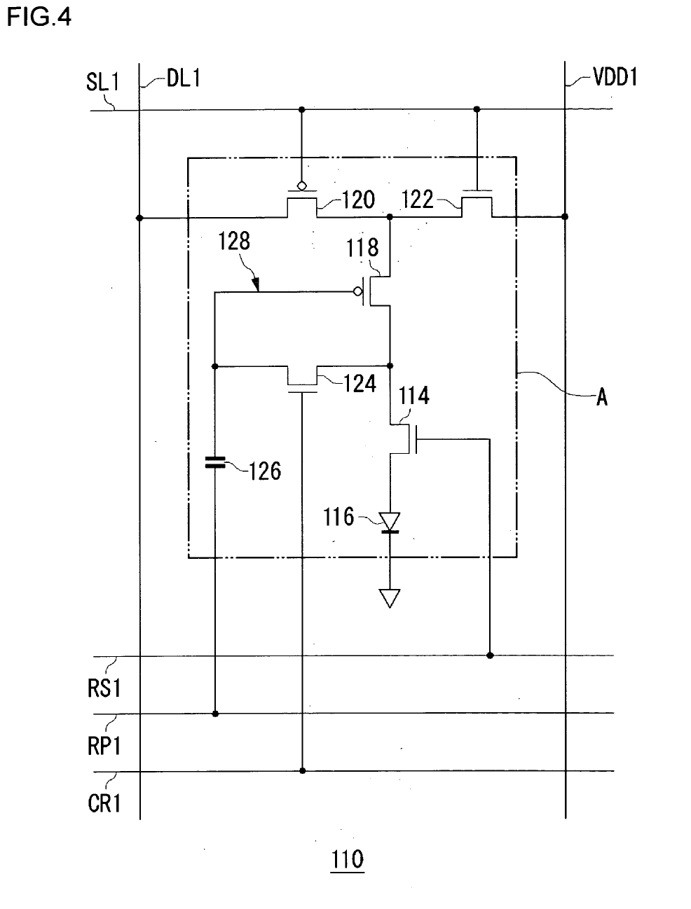

FIG. 4 illustrates a basic structure of a pixel included in a display apparatus according to the second embodiment of the present invention. In a display apparatus 110, a first pixel A includes an OLED 116, a reset transistor 114, a drive transistor 118, a write transistor 120, a power supply transistor 122, a correction transistor 124 and a holding capacitance 126. However, the write transistor 120, which is a p-channel MOS transistor, differs from that of the first embodiment, which is an n-channel MOS transistor. Also, the power supply transistor 122, which is an n-channel MOS transistor, differs from that of the first embodiment, which is a p-channel MOS transistor. Furthermore, this second embodiment differs from the first embodiment in that the gate electrode of the correction transistor 124 is connected to a correction signal line CR1.

The write transistor 120 has a source electrode thereof connected to a first data signal line DL1 and a drain electrode thereof connected to a source electrode of the power supply transistor 122 and a source electrode of the drive transistor 118. A gate electrode of the write transistor 120 is connected to a first selection signal line SL1. The power supply transistor 122 has a drain electrode thereof connected to a first power supply line VDD1 and a gate electrode thereof connected to the first selection signal line SL1. A drain electrode of the drive transistor 118 is connected to a source electrode of the correction transistor 124 and a drain electrode of the reset transistor 114. A drain electrode of the correction transistor 124 is connected to a gate electrode of the drive transistor 118 and one end of the holding capacitance 126. The other end of the holding capacitance 126 is connected to a first ramp signal line RP1. A gate electrode of the correction transistor 124 is connected to the correction signal line CR1. The reset transistor 114 has a source electrode thereof connected to an anode of the OLED 116 and a gate electrode thereof connected to a first reset line RS1. The holding capacitance 126 holds a luminance signal set at the gate electrode of the drive transistor 118.

In this second embodiment, too, one horizontal line selection period is divided into two parts, the first half serving as a luminance signal write period and the second half as an emission period in the control of each pixel. Since the write transistor 120 is a p-channel MOS transistor and the power supply transistor 12.2 is an n-channel MOS transistor, the polarity of a selection signal of the first selection signal line SL1 is in an inverted form of the selection signal of the first embodiment. The correction transistor 124 is controlled by the correction signal of the correction signal line CR1. In the write period, therefore, when a selection signal is low, the correction signal is high, so that the write transistor 120 and the correction transistor 124 are turned on and the power supply transistor 122 is turned off. On the other hand, when a selection signal goes high and the correction signal goes low, the write transistor 120 and the correction transistor 124 are turned off and the power supply transistor 122 is turned on. The voltage changes of other signals and the operation of the transistors are the same as those of the first embodiment.

By implementing the above structure, Vdata-Vtp, which is a value of the voltage of a luminance signal corrected by the threshold voltage of the drive transistor 118, is also written to the gate electrode of the drive transistor 118. As a result, the OLED 116 can be turned on independently of the threshold voltage of the drive transistor 118, so that there occurs no variation in display between the pixels. Also, no current flows to the OLED 116 during the write period, when the drive transistor 118 is off, and no through current flows in the drive transistor 118. Hence, while power consumption by the display apparatus 110 as a whole is held low, the optical elements can be driven independently of any variation in characteristics of the drive circuit and thus luminance irregularity of the display apparatus can be avoided.

The present invention has been described based on the first and second embodiments which are only exemplary. It is therefore understood by those skilled in the art that there exist other various modifications to the combination of each component and process described above and that such modifications are also within the scope of the present invention.

In each of the first and the second embodiment, a drive transistor 118 is operated by gradually dropping a ramp signal inputted from a first ramp signal line RP1. In a modification thereof, the voltage of a ramp signal in the first ramp signal line RP1 may be raised gradually. In this case, a low-level ramp signal is once inputted to each of the pixels to have their respective drive transistors 118 operate and their respective OLEDs 116 emit light, and then the voltage of the ramp signal is raised gradually. Of the plurality of pixels, the pixels, as the potential at the node 128 reaches a value smaller by Vtp than the power supply potential, sequentially turn off their respective drive transistors 118 and thus their respective OLEDs 116. In this manner, a multiple-gradation display is realized by modulating the light emission time of each pixel.

In each of the first and the second embodiment, the structure where the write transistor 120 and the power supply transistor 122 are both connected to the first selection signal line SL1 and controlled by the same selection signals have been described. However, in a modification thereof, the write transistor 120 and the power supply transistor 122 may be connected to their separate signal lines and controlled by their separate signals. Furthermore, the transistors may be controlled by their separate signals, and all the transistors used may be p-channel MOS transistors.

### Third Embodiment

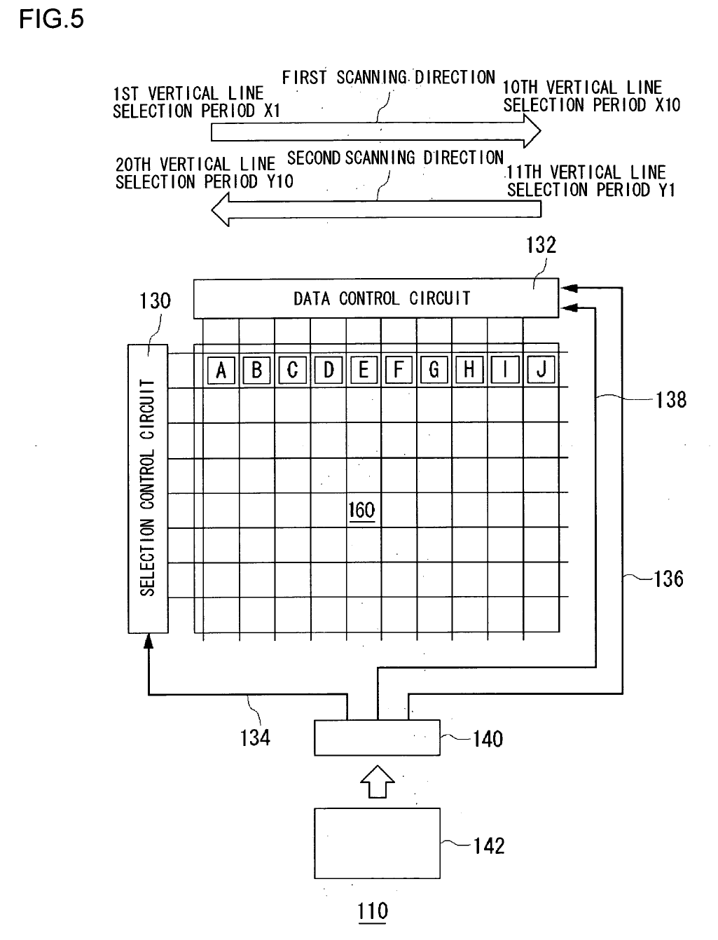

FIG. 5 illustrates a basic structure of a pixel region and its periphery included in a display apparatus according to a third embodiment of the present invention. A display apparatus 110 is a point sequential drive type active matrix display apparatus. In the display apparatus 110, a plurality of selection signal lines and a plurality of data signal lines are so arranged as to intersect each other, and a plurality of pixels, each disposed at an intersecting position thereof, are arranged in a matrix in a pixel region 160. The plurality of pixels each include an optical element, which emits light controlled by a selection control circuit 130 via a selection signal line and a data control circuit 132 via a data signal line.

The selection control circuit 130 selects, for each row, pixels to be subjected to input control by a luminance signal. The selection control circuit 130 according to the third embodiment scans a plurality of horizontal pixel lines, which are rows in the pixels, by sending a selection signal, which selects a horizontal pixel line, sequentially from top row down. The selection signal is inputted to each of the pixels contained in a horizontal pixel line via a corresponding selection signal line.

The data control circuit 132 inputs a luminance signal sequentially to each of the pixels included in a horizontal pixel line having been selected by the selection control circuit 130. The luminance signal is inputted to each of the pixels via their respective data signal lines. The following description of this third embodiment will be given on the assumption that pixels from a first pixel A to a 10th pixel J are arranged on a horizontal pixel line as illustrated in FIG. 5.

An external drive circuit 142 inputs a vertical drive signal to the selection control circuit 130 via an interface 140 and a vertical drive signal line 134. The external drive circuit 142 also inputs a horizontal drive signal to the data control circuit 132 via the interface 140 and a horizontal drive signal line 136 and inputs an image signal to the data control circuit 132 via the interface 140 and an image signal line 138. An image signal includes luminance signals for a plurality of colors to be inputted to their respective pixels.

The luminance signal included in an image signal is inputted two times per frame to each of the pixels included in a horizontal pixel line having been selected by the selection control circuit 130. That is, the luminance signals for a frame are inputted to the pixels from the first pixel A to the 10th pixel J sequentially in the first scanning direction (left to right in the figure) and then the luminance signals for the same frame are inputted to the pixels from the 10th pixel J to the first pixel A sequentially in the second scanning direction (right to left in the figure). More specifically, in the input in the first scanning direction, the data control circuit 132 inputs the respective luminance signals to the pixels from the first pixel A to the 10th pixel J sequentially in their respective periods from the first vertical line selection period X1 to the 10th vertical line selection period X10. And, in the input in the second scanning direction, the data control circuit 132 inputs the respective luminance signals to the pixels from the 10th pixel J to the first pixel A sequentially in their respective periods from the 11th vertical line selection period Y1 to the 20th vertical line selection period Y10.

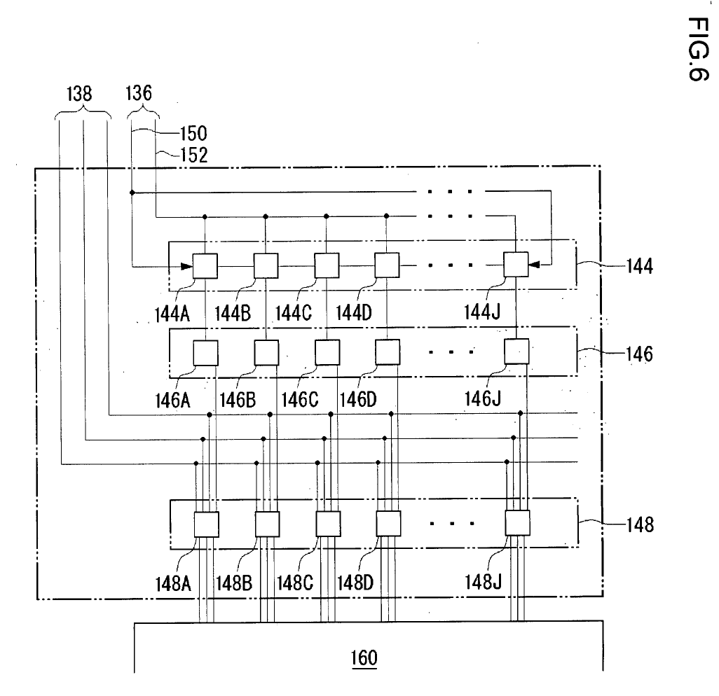

FIG. 6 illustrates a detailed structure of a data control circuit 132. Image signal lines 138, which allow luminance signals flow via an interface 140 from an external drive circuit 142, are connected to each of a plurality of switches 148A to 148J included in a switch circuit 148. A start signal 150 and a scanning direction switching signal 152 are contained in a horizontal drive signal, which is sent from the external drive circuit 142 via the interface 140 and the horizontal drive signal line 136. The start signal 150 is inputted to a shift register 144A at the left end and a shift register 144J at the right end of a plurality of shift registers 144A to 144J in a shift register circuit 144. The scanning direction switching signal 152 is inputted to each of the plurality of shift registers 144A to 144J. A buffer circuit 146 includes a plurality of buffers 146A to 146J, and the plurality of shift registers 144A to 144J are connected to their corresponding buffers of the plurality of buffers 146A to 146J. The plurality of buffers 146A to 146J are connected to their corresponding switches of the plurality of switches 148A to 148J.

When luminance signals are to be inputted to their respective pixels sequentially in the first scanning direction, the shift register 144A, upon the input of a start signal 150 thereto, sends a pulse signal to the corresponding buffer 146A and the next shift register 144B. Upon the input of a pulse signal from the shift register 144A, the shift register 144B sends a pulse signal to the corresponding buffer 146B and the next shift register 144C. In this manner, a pulse signal is sent at each clock sequentially from shift register 144A to shift register 144J.

When a pulse signal is sent from the shift register 144A to the buffer 146A, the switch 148A is turned on, a luminance signal is sent through the switch 148A to the first pixel A, and the first vertical line selection period X1 is started. When a pulse signal is sent from the shift register 144B to the buffer 146B, the switch 148B is turned on, a luminance signal is sent through the switch 148B to the second pixel B, and the second vertical line selection period X2 is started. In this manner, when pulse signals are sent sequentially from the shift registers 144A to 144J to the buffers 146A to 146J, respectively, the switches 148A to 148J are turned on sequentially. Now luminance signals are sent through the switches to the first pixel A to the 10th pixel J, respectively, and the first vertical line selection period X1 to the 10th vertical line selection period X10 are started sequentially.

The data control circuit 132 performs the above-described control whenever the selection control circuit 130 selects a horizontal pixel line. When the selection control circuit 130 has completed sequentially selecting all the horizontal pixel lines contained in a screen and returns to the first horizontal pixel line, a scanning direction switching signal 152 to reverse the scanning direction is sent to the data control circuit 132, and the scanning direction switching signal 152 are inputted to each of the shift registers 144A to 144J, thus reversing the input/output direction of a pulse signal at each of the shift registers from the first scanning direction to the second scanning direction. Accordingly, when a start signal 150 is inputted to the shift register 144J, pulse signals are sent sequentially from the shift registers 144J to 144A to the buffers 146J to 146A, respectively, the switches 148J to 148A are turned on sequentially, luminance signals are sent through the switches to the 10th pixel J to the first pixel A, respectively, and the 11th vertical line selection period Y1 to the 20th vertical line selection period Y10 are started sequentially.

The luminance signals sent through the switches to the 10th pixel J to the first pixel A, respectively, in the second scanning direction are the same as those sent through the switches to the first pixel A to the 10th pixel J, respectively, in the first scanning direction. Hence, the sequence of luminance signals which the external drive circuit 142 sends to the data control circuit 132 via the interface 140 is reversed between the first scanning direction and the second scanning direction. In other words, the external drive circuit 142 sends respective luminance signals in the sequence of the first pixel A to the 10th pixel J at the time of first scanning direction and in the sequence of the 10th pixel J to the first pixel A at the time of second scanning direction. It is to be noted here that even when the switches in the switch circuit 148 are off, the luminance signals keep being inputted to the pixels because the luminance signals sent through the switches are held on the signal lines for a predetermined period of time.

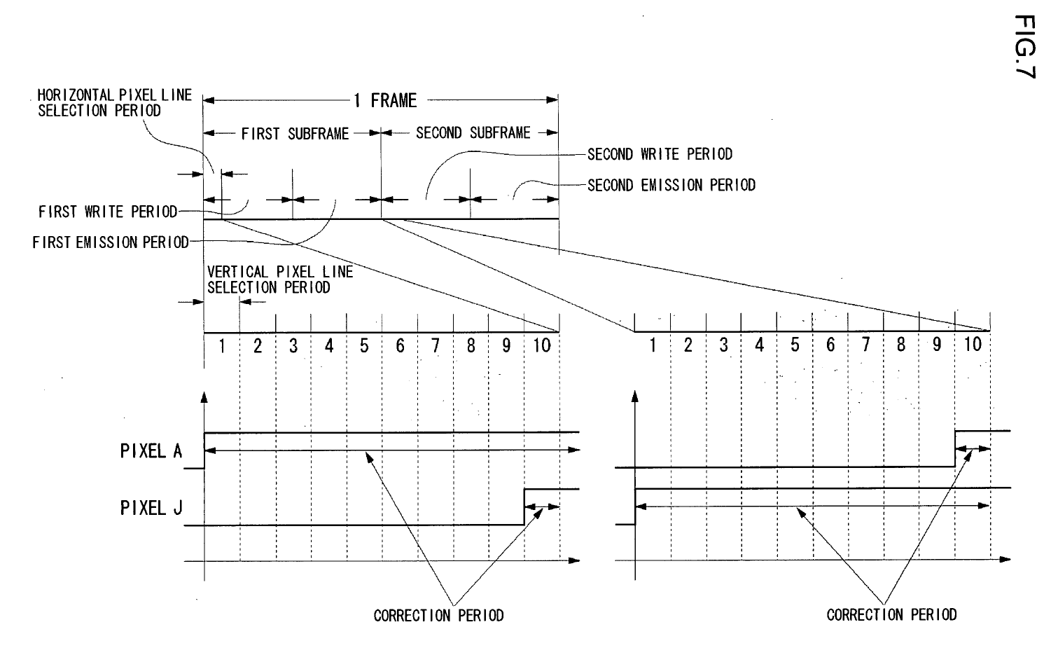

FIG. 7 schematically illustrates detailed drive timing in one frame period. To allow the input of the same luminance signals to their respective pixels two times per frame, one frame period is divided into two periods (hereinafter referred to as “subframe periods”), namely, the first subframe period and the second subframe period. The first subframe period and the second subframe period are each further divided into a write period and an emission period. The same luminance signals are inputted to their respective pixels in each of the first write period in the first subframe period and the second write period in the second subframe period.

The clock frequency for the input of luminance signals in this third embodiment is equal to twice the frame frequency for showing change in frames to be displayed. For example, when the frame frequency is 60 Hz, the clock frequency for luminance signals may be set at 120 Hz. Or, conversely, the clock frequency for luminance signals may be set to 60 Hz and the frame frequency may be controlled to 30 Hz.

The first write period and the second write period each include as many selection periods as the number of the horizontal pixel lines. One horizontal pixel line selection period includes as many selection periods as the number of the vertical pixel lines. The description for the third embodiment, however, will be given on the assumption that there are 10 vertical pixel lines for the pixels from the first pixel A to the 10th pixel J. In this case, during the first write period, a sufficient correction can be made for the first pixel A, with the luminance signal corrected by an operation threshold value of the drive circuit from the start of the first vertical pixel line selection period till the end of the 10th vertical pixel line selection period. For the second pixel B, a correction can be made from the second vertical pixel line selection period to the 10th vertical pixel line selection period. In this manner, the correction enabled period gets shorter one vertical pixel line selection period at a time from the first pixel A to the 10th pixel J, so that, if the length of one vertical pixel line selection period is 1, then the lengths of correction enabled period for the pixels from the first pixel A to the 10th pixel J are (10, 9, 8, 7, 6, 5, 4, 3, 2, 1), respectively. As a result, the correction enabled period for the 10th pixel J is as short as 1/10 of that for the first pixel A.

On the other hand, during the second write period, when the scanning direction is reversed, a sufficient correction can be made firstly for the 10th pixel J, with the luminance signal corrected by the operation threshold value of the drive circuit from the start of the first vertical pixel line selection period till the end of the 10th vertical pixel line selection period. For the 9th pixel I, a correction can be made from the second vertical pixel line selection period to the 10th vertical pixel line selection period. In this manner, the correction enabled period gets shorter one vertical pixel line selection period at a time from the 10th pixel J to the first pixel A, so that the lengths of the respective correction enabled periods are (10, 9, 8, 7, 6, 5, 4, 3, 2, 1), respectively. As a result, the correction enabled period for the 10th pixel J is as long as 10 times that for the first pixel A.

As described above, the right-hand pixels, such as the 10th pixel J and the 9th pixel I, which have shorter correction enabled periods in the first write period, have sufficiently long correction enabled periods in the second write period. Conversely, the left-hand pixels, such as the first pixel A and the second pixel B, which have shorter correction enabled periods in the second write period, have sufficiently long correction enabled periods in the first write period. Therefore, this continuous processing of this twice-per-frame display control at a clock frequency, which is 2 times the frame frequency, produces an effect in which the viewer sees the two images overlapped on the screen. Hence, even when there occurs an image quality drop, such as a fluctuation in luminance or gradation level, in one of the images, it can be visually compensated for by the other. This results in a relative improvement in image quality by reducing image deterioration as a whole.

The basic structure of a pixel included in a display apparatus according to the third embodiment may be the same as that of the first embodiment as shown in FIG. 1. The other pixels, such as the second pixel B to the 10th pixel J, have the same structure. The structure of each pixel in the present embodiment is not limited to the one illustrated in the figure, but may be replaced by any other structure so long as the circuit can correct the luminance signals by compensating for the variation in characteristics of the drive circuit.

Referring to FIG. 1 representing also a basic structure of the third embodiment, a first data signal line DL1 is connected to a data control circuit 132, and a luminance signal is sent from the data control circuit 132. A first selection signal line SL1 is connected to a selection control circuit 130, and a selection signal is sent from the selection control circuit 130. A first reset line RS1 and a first ramp signal line RP1 are also connected to the selection control circuit 130, and a reset signal or a ramp signal is sent from the selection control circuit 130.

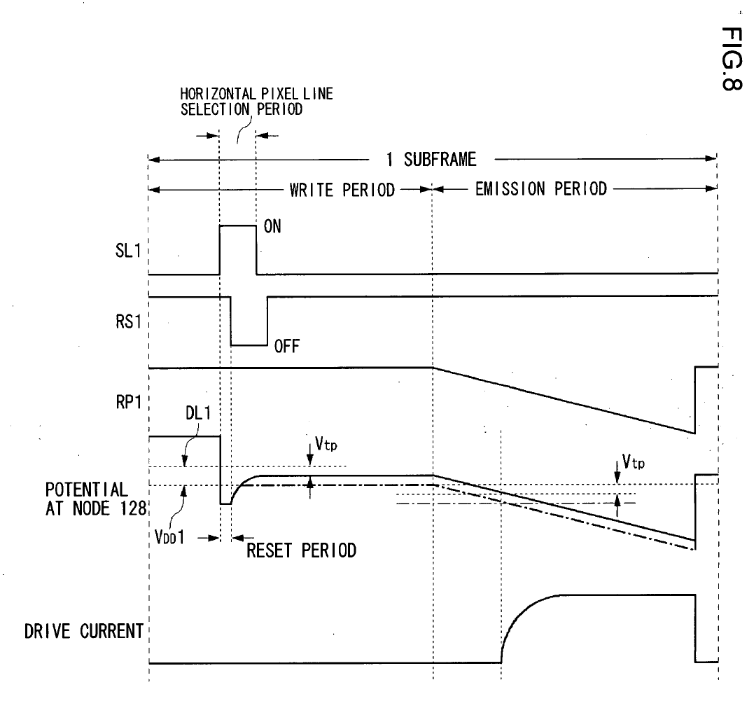

FIG. 8 is a timing chart showing a state change relationship among signals inputted to a first pixel A. As shown in FIG. 8, one subframe period is divided into two parts, the first half serving as a luminance signal write period and the second half as an emission period in the control of each pixel. The basic operations of those signals are the same as those described in the first embodiment with reference to FIG. 3.

As shown in FIG. 3, the voltage of a luminance signal is corrected by a threshold value of the drive transistor 118, and there is a certain time lapse between the input of a luminance signal and the turning off of the drive transistor 118.

The timing with which a selection signal goes high in a write period, that is, the timing with which a horizontal pixel line selection period starts, varies with the horizontal pixel line. The input timing of a luminance signal in a horizontal pixel line selection period varies with the vertical pixel line, and therefore there is a possibility that there is not enough time from the input of a luminance signal to the end of correction in a vertical pixel line where the input timing of a luminance signal is late. According to the third embodiment, however, the scanning direction is reversed and the same luminance signals are inputted again to the same pixels, so that in the second write period, enough correction enabled period is secured for the vertical pixel lines for which correction has not been enough. In this manner, the degradation of image quality is compensated for.

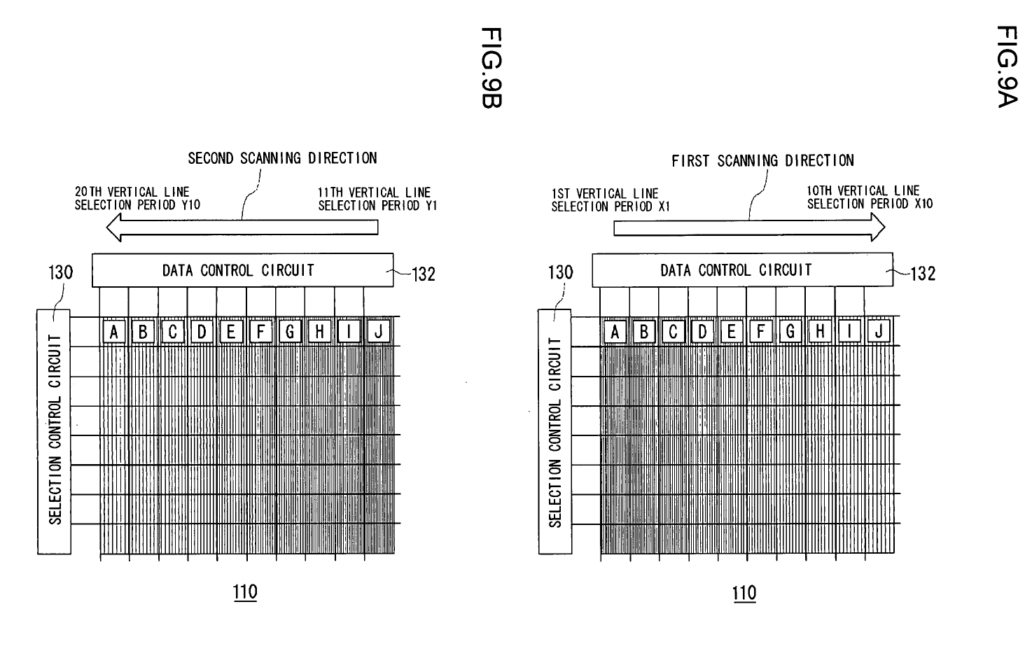

FIG. 9A and FIG. 9B schematically illustrate the display status of each pixel in a first subframe period and a second subframe period. In the first subframe period, luminance signals are inputted sequentially in the first scanning direction from the first pixel A to the 10th pixel J. Compared with the pixels on the first pixel A side, the pixels on the 10th pixel J side have shorter correction enabled period for the luminance signals and thus there is a possibility of inadequate correction for the luminance signals. As illustrated in FIG. 9A, which shows a variation in gradation level in the horizontal direction, the right-hand pixels may be increasingly subject to inadequate correction. It is to be noted here that the gradation in the illustration is simply a representation of the lengths of correction enabled periods for luminance signals on the respective vertical pixel lines and does not represent the gradation of luminance itself.

In the second subframe period, luminance signals are inputted sequentially in the second scanning direction from the 10th pixel J to the first pixel A. Compared with the pixels on the 10th pixel J side, the pixels on the first pixel A side have shorter correction enabled period for the luminance signals and thus there is a possibility of inadequate correction for the luminance signals. As illustrated in FIG. 9B, which shows a variation in gradation level in the horizontal direction, the left-hand pixels may be increasingly subject to inadequate correction.

For the vertical pixel lines for which correction of luminance signals is not sufficient in the first subframe period as shown in FIG. 9A, sufficient correction of the luminance signals is done in the second subframe period as shown in FIG. 9B. Accordingly, the consecutive display of the two subframes has any gradation irregularity in one subframe evened out by the other. As a result, an image display with a least marked gradation irregularity is realized, thus improving the image quality.

### Fourth Embodiment

In a fourth embodiment of the present invention, the scanning direction is reversed for every scanning of a horizontal pixel line, in contrast to the third embodiment, in which a display is made in the same scanning direction in the first subframe period and the scanning direction is reversed in the next subframe period. Other structural components are the same as the third embodiment and the description thereof is omitted here. And the following description will center on the difference from the third embodiment.

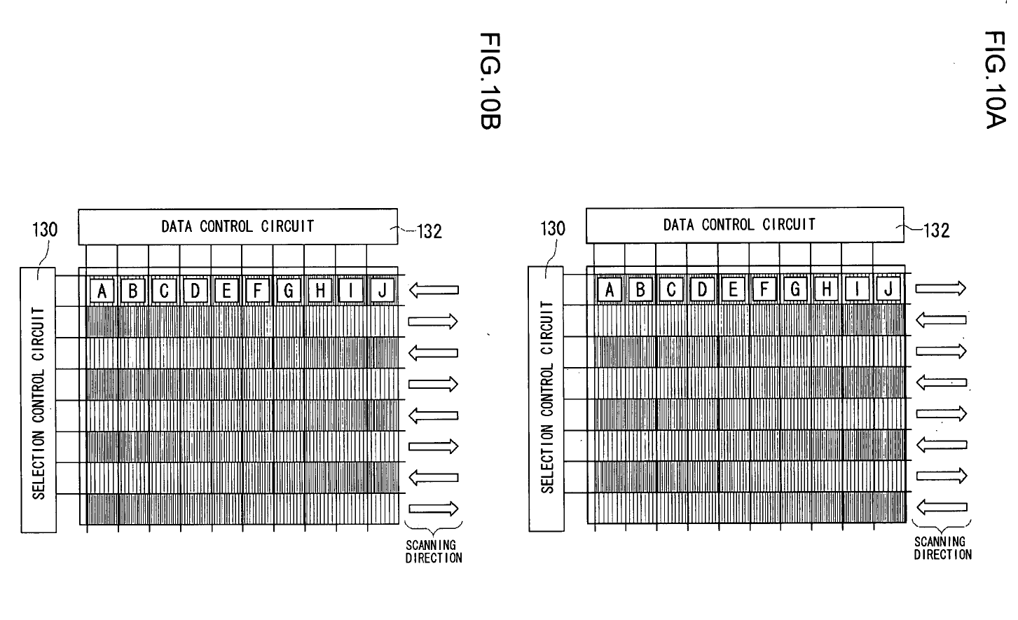

FIG. 10A and FIG. 10B schematically illustrate the display status of each pixel in a first subframe period and a second subframe period according to the fourth embodiment. In the first subframe period shown in FIG. 10A, luminance signals are inputted sequentially in the direction of the first pixel A toward the 10th pixel J for the first horizontal pixel line and sequentially in the direction of the 10th pixel J toward the first pixel A for the next horizontal pixel line. Then for the still next horizontal pixel line, luminance signals are inputted sequentially from the first pixel A to the 10th pixel J and then from the 10th pixel J to the first pixel A for the next. This way, the scanning direction is reversed for every horizontal pixel line. In this case, the pixels with shorter correction enabled period, and therefore insufficient correction, for the luminance signals alternate from the right-hand side to the left-hand side, and then to the right-hand side and to the left-hand side and so on, for every horizontal pixel line.

In the second subframe period shown in FIG. 10B, luminance signals are inputted sequentially in the direction of the 10th pixel J toward the first pixel A for the first horizontal pixel line and sequentially in the direction of the first pixel A toward the 10th pixel J for the next horizontal pixel line. Then for the still next horizontal pixel line, luminance signals are inputted sequentially from the 10th pixel J to the first pixel A and then from the first pixel A to the 10th pixel J for the next. This way, the scanning direction is reversed for every horizontal pixel line. In this case, the pixels with shorter correction enabled period, and therefore insufficient correction, for the luminance signals alternate from the left-hand side to the right-hand side, and then to the left-hand side and to the right-hand side and so on, for every horizontal pixel line.

In this manner, in the first subframe period, the scanning direction is reversed for every horizontal pixel line, and in the second subframe period, the scanning direction is reversed for every horizontal pixel line in the directions opposite to those in the first subframe period. As a result, similar to the third embodiment, the consecutive display of the two subframes has any gradation irregularity in one subframe evened out by the other. Thus an image display with a least marked gradation irregularity is realized. Furthermore, the reversion of scanning direction for every horizontal pixel line also evens out the right or left deviation of gradation irregularity that can occur in every subframe. This also improves the image quality by further reducing the gradation irregularity.

The present embodiment is only exemplary, and it is therefore understood by those skilled in the art that there exist other various modifications to the combination of each component and process described above and that such modifications are also within the scope of the present invention. Such modifications of the third and fourth embodiments will be described hereinbelow.

In each of the foregoing embodiments, the scanning direction has been described concretely as from right to left or from left to right, but in a modified example, such sequences may be reversed. Also, in the fourth embodiment, description was given of an example in which the scanning direction is reversed for each horizontal pixel line, but in a modified example, the scanning direction may be reversed for every plurality of horizontal pixel lines. In such case, too, there is a similar advantageous effect of evening out the right or left deviation of gradation irregularity. Moreover, in each of the foregoing embodiments, description has been given of an example in which the same frame is displayed twice consecutively, but in a modified example, the same frame may be displayed three times or more consecutively.

### Fifth Embodiment

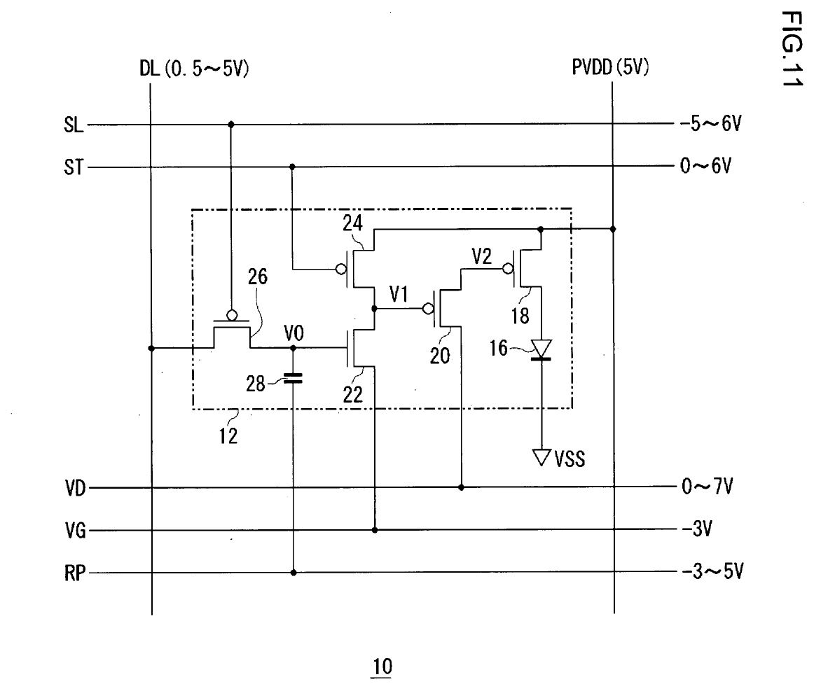

FIG. 11 illustrates a basic structure of a pixel included in a display apparatus according to a fifth embodiment of the present invention. The display apparatus 10 is an active matrix type display apparatus which performs display control using a time gradation system. In the display apparatus 10, a plurality of pixels are arranged in a matrix, and one of them is a pixel 12 shown in FIG. 11. The pixel 12 includes an organic light-emitting diode OLED 16, a drive transistor 18, a drive control transistor 20, a time control transistor 22, a set transistor 24, a write transistor 26 and a holding capacitance 28.

The drive transistor 18, the drive control transistor 20, the set transistor 24 and the write transistor 26 are p-channel MOS transistors. The time control transistor 22 is an n-channel MOS transistor. The OLED 16, which is a current-driven-type optical element, emits light at an intensity corresponding to a current value when a drive current flows. In the fifth embodiment, however, the value of the drive current is fixed, and therefore the gradation is expressed by the length of emission period of each pixel.

The write transistor 26 has a gate electrode thereof connected to a selection signal line SL, a source electrode thereof connected to a data signal line DL and a drain electrode thereof connected to a gate electrode of the time control transistor 22. A selection signal of the selection signal line SL has its voltage change between −5 V and 6 V. A luminance signal of the data signal line DL has its voltage change between 0.5 V and 5 V. The connection between the drain electrode of the write transistor 26 and the gate electrode of the time control transistor 22 is a first node V0. The holding capacitance 28 is provided between the first node V0 and a ramp signal line RP. From the ramp signal line RP, a ramp signal, which changes between −3 V and 5 V, is inputted to the holding capacitance 28.

The time control transistor 22 has a source electrode thereof connected to a time control potential VG and a drain electrode thereof connected to a drain electrode of the set transistor 24. The time control potential VG is −3 V. The set transistor 24 has a gate electrode thereof connected to a set signal line ST and a source electrode thereof connected to a power supply potential PVDD. A set signal of the set signal line ST has its voltage change between 0 V and 6 V. The power supply potential PVDD has a potential of 5 V. A common drain electrode of the time control transistor 22 and the set transistor 24 is connected to a gate electrode of the drive control transistor 20.

The drive control transistor 20 has a drain electrode (source electrode) thereof connected to a drive control signal line VD and a source electrode (drain electrode) thereof connected to a gate electrode of the drive transistor 18. A drive control signal of the drive control signal line VD has its voltage change between 0 V and 7 V. The drive transistor 18 has a source electrode thereof connected to the power supply potential PVDD and a drain electrode thereof connected to an anode of the OLED 16. A cathode of the OLED 16 is connected to a low potential VSS.

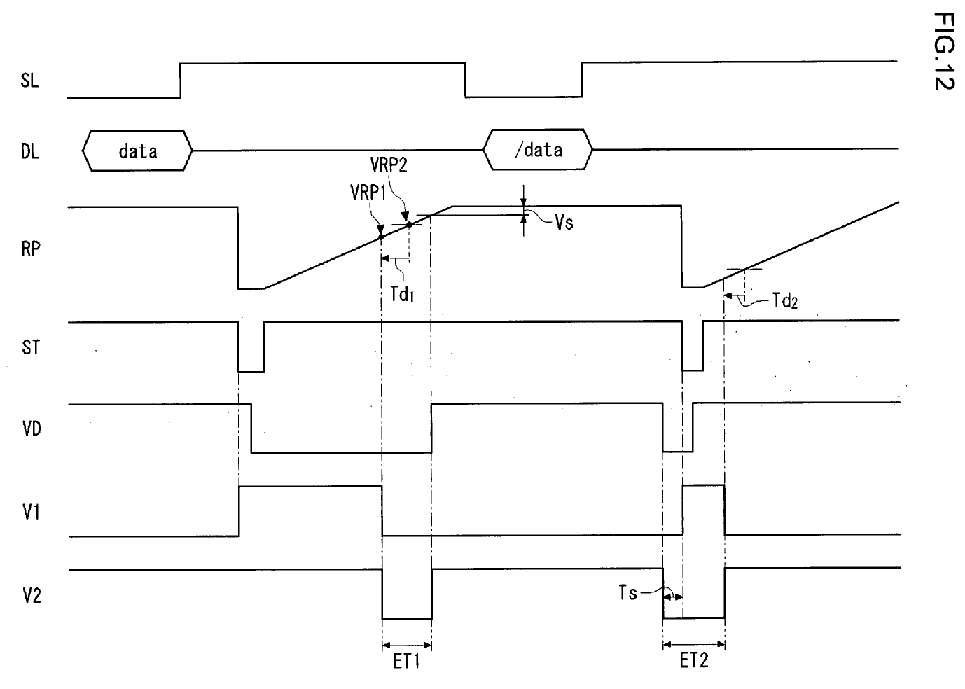

FIG. 12 is a timing chart showing a state change relationship among control signals inputted to a display apparatus 10 according to the fifth embodiment. Firstly, as preparation for a first light emission, when a selection signal of a selection signal line SL is low and a write transistor 26 is on, a luminance signal indicating an emission timing is inputted to a first node V0 and the potential is set at a gate electrode of a time control transistor 22. At this time, the time control transistor 22 is turned on, but a set transistor 24 remains off because a set signal of a set signal line ST is high. Now the potential at a second node V1, which is between the drain electrode of the time control transistor 22 and the gate electrode of the drive control transistor 20, goes low, so that the drive control transistor 20 is turned on. At this time, a drive control signal of the drive control signal line VD is high, and therefore the potential at a third node V2, which is between the source electrode of the drive control transistor 20 and a gate electrode of a drive transistor 18, goes high and the drive transistor 18 remains off.

When the selection signal line SL goes high, the write transistor 26 is turned off, but the potential at the first node V0 is maintained by the holding capacitance 28. Now a ramp signal of the ramp signal line RP drops from high to low and the potential at the first node V0 drops, so that the time control transistor 22 is turned off. With practically the same timing, the set signal goes low, the set transistor 24 is turned on, and the potential at the second node V1 goes high as it is coupled to a power supply potential PVDD. Thus the drive control transistor 20 is turned off. Thereafter the drive control signal goes low.

In this manner, in the preparation for the first light emission, the drive control signal goes low while the third node V2 is high and the drive control transistor 20 is off. Accordingly, if the time control transistor 22 and the drive control transistor 20 turn on as a result of a rise in the potential at the first node V0, the drive transistor 18 will also turn on, thus preparing the OLED 16 to start emitting light. Thus the emission start of the OLED 16 will be controlled in response to a luminance signal inputted to the first node V0.

Next, the set signal goes high and the set transistor 24 is turned off to cut off the time control transistor 22 from the power supply potential PVDD, then the potential of the ramp signal rises gradually and the potential at the first node V0 also rises gradually. And when the potential at the first node V0 reaches a value (VG+Vt), which is the sum of a time control potential VG and an operation threshold value Vt of the time control transistor 22, the time control transistor 22 turns on. It is assumed here that the potential of the ramp signal when the time control transistor 22 turns on is VRP1. If the time control transistor 22 turns on, then the potential at the second node V1 will drop and the drive control transistor 20 will turn on. With the drive control transistor 20 turning on, the potential at the third node V2 also drops and the drive transistor 18 turns on. Thus a drive current flows to the OLED 16, which in turn starts emitting light. Then, as the drive control signal goes high with a predetermined timing, the third node V2 goes high and the drive transistor 18 is turned off. Thus a drive current is cut off from the OLED 16, which in turn stops the light emission of the OLED 16.

Due to variation in transistor characteristics, there are cases where the operation threshold value Vt of the time control transistor 22 is different from the standard value, which is assumed to be an ideal value. The operation threshold value Vt presented as an example in the fifth embodiment is lower than the standard value, and as a consequence, the time control transistor 22 turns on when the potential at the first node V0 exceeds VRP1, which is lower than VRP2, which is primarily where it must turn on, as shown in FIG. 12. That is, the emission start timing of the OLED 16, is earlier by Td1 and thus the first light emission period is longer by Td1.

If the operation threshold value Vt of the time control transistor 22 is higher than the standard value, the emission start timing of the OLED 16 will be delayed by a certain length of time and thus the first light emission period will be shorter by the same length of time. The value used for a ramp signal at the stop of light emission is to be one that assures a margin Vs so that the OLED 16 can emit light even when the luminance signal is one indicating “black” in a linear part of the ramp signal.

As preparation for a second light emission, when a selection signal goes low again and the write transistor 26 is turned on, a luminance signal indicating an emission stop timing is inputted to the first node V0 from the data signal line DL. The luminance signal indicating an emission stop timing is the inverse of the luminance signal indicating an emission timing inputted to the first node V0 in the preparation for the first light emission. Even when the selection signal returns to high, the voltage of the luminance signal is held in the holding capacitance 28. When a drive control signal goes low, the third node V2 goes low, too. When the drive transistor 18 turns on, a drive current flows to the OLED 16, which in turn starts emitting light for the second time. Immediately after that, the ramp signal goes low and the time control transistor 22 is turned off. Now when the set signal becomes a low pulse and the set transistor 24 turns on, the second node V1, coupled to the power supply potential PVDD, goes high and the drive control transistor 20 turns off. As a result, the potential at the third node V2 is maintained, and the light emission by the OLED 16 is maintained. During this time, the drive control signal goes high.

In this manner, in the preparation for a second light emission, the drive control signal goes high while the third node V2 is low and the drive control transistor 20 is off. Accordingly, if the time control transistor 22 and the drive control transistor 20 turn on as a result of a rise in the potential at the first node V0, the drive transistor 18 will also turn on, thus preparing the OLED 16 to stop emitting light. Thus the emission end of the OLED 16 will be controlled in response to a luminance signal inputted to the first node V0.

Then as the ramp signal begins to rise again, the potential at the first node V0 begins to rise, too. When the potential at the first node V0 reaches (VG+Vt), the time control transistor 22 turns on, the potential at the second node V1 drops, and the drive control transistor 20 turns on. With the drive control transistor 20 turning on, the potential at the third node V2 rises, the drive transistor 18 turns off, and the OLED 16 stops emitting light.

In the second light emission, emission is started a moment before the ramp signal rises. The duration Ts, however, is less than 10 μs, which cannot be recognized visually and thus ignorable. Nevertheless, it may also be so arranged that another transistor is added in series to the drive transistor 18 and light emission is stopped by shutting off a drive current to the OLED 16 until the ramp signal begins to rise.

In a pixel 12 according to this fifth embodiment, signals, whose potential is sufficiently higher or sufficiently lower than that at source electrodes, are inputted to the gate electrodes of transistors other than the time control transistor 22. Accordingly, such transistors operate practically as switches, so that there is no problem with variation in their respective operation threshold values.

With the time control transistor 22, however, some difference in emission start timing or emission stop timing may sometimes occur depending on the variation in the operation threshold value Vt. In the fifth embodiment, an emission time for a given luminance signal is divided into two times of emission, and for the first emission, the emission start timing is controlled according to the luminance signal and for the second emission, the emission stop timing is controlled according to the luminance signal. Here, if the operation threshold value Vt of the time control transistor 22 is lower than the standard value, the time control transistor 22, for the first light emission, will turn on earlier by Td1, which corresponds to the difference of the operation threshold value Vt below the standard value. As a result, the light emission will start earlier and thus the emission time will be longer by Td1. On the other hand, for the second light emission, the light emission will be stopped earlier by Td2, which corresponds to the difference of the operation threshold value Vt below the standard value, and thus the emission time will be shorter by Td2. Since Td1 and Td2 are the same length of time, the difference in emission timing due to the operation threshold value Vt is canceled by the difference in emission stop timing due to the operation threshold value Vt. Hence, the sum of the first emission time and the second emission time is constant irrespective of the variation in the operation threshold value Vt, thus producing a condition no different from when the operation threshold value is the standard value. As a result, a good image quality can be maintained.

Similarly, if the operation threshold value Vt of the time control transistor 22 is higher than the standard value, the time control transistor 22, for the first light emission, will turn on later by a length of time, which corresponds to the difference of the operation threshold value Vt above the standard value. As a result, the light emission will start later and thus the emission time will be shorter by said length of time. On the other hand, for the second light emission, the time control transistor 22 will turn on later by a length of time, which corresponds to the difference of the operation threshold value Vt above the standard value. As a result, the emission stop timing will be delayed and thus the emission time will be longer. In this case, too, the difference in emission timing due to the operation threshold value Vt is canceled by the difference in emission stop timing due to the operation threshold value Vt. Hence, the sum of the first emission time and the second emission time is equal to that when the operation threshold value is the standard value. Thereby a good image quality can be maintained.

Thus, luminance irregularity due to the variation in transistor characteristics is avoided because the sum of the first and the second emission time does not change with the variation in the operation threshold value Vt of the time control transistor 22. It is to be appreciated that one frame period is an instant to the human senses and therefore the two separate times of light emission employed in the fifth embodiment do not look like blinking to the human eyes. Hence, the first and the second emission, even if a balance is lost between the two emission times, are visually perceived as a single continued light emission. Thus a balance between the emission times is not a requisite so long as the sum of the first and the second light emission is the same.

### Sixth Embodiment

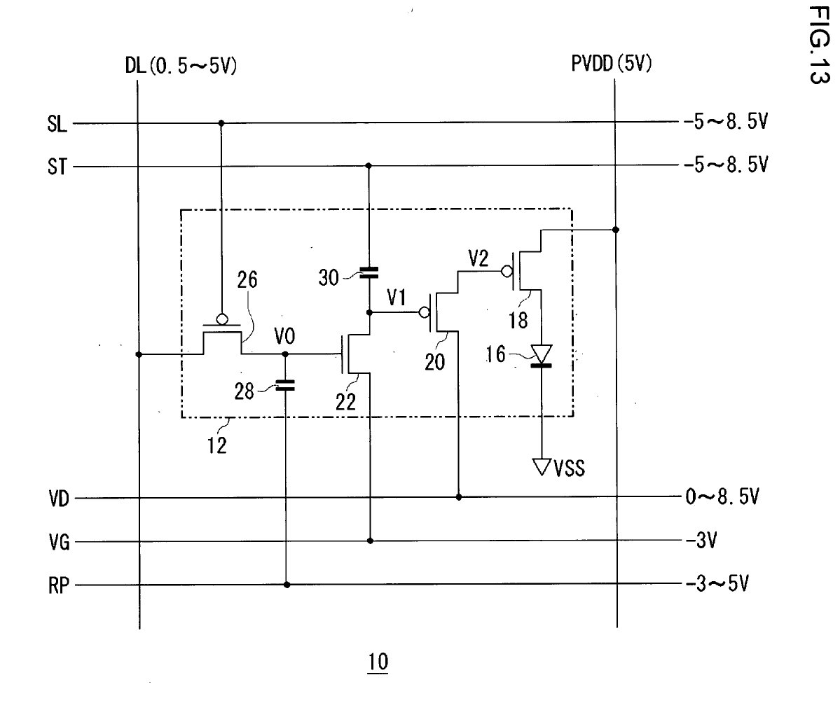

FIG. 13 illustrates a basic structure of a pixel included in a display apparatus according to a sixth embodiment of the present invention. In this sixth embodiment, the circuit configuration within a pixel differs partially from that of the fifth embodiment. And the following description will center on the difference from the fifth embodiment.

A pixel 12 includes an OLED 16, a drive transistor 18, a drive control transistor 20, a time control transistor 22, a write transistor 26, a holding capacitance 28 and a set capacitance 30. The structure and arrangement thereof, except for the set capacitance 30, are the same as those of the fifth embodiment, excluding the set transistor 24 therein. The set capacitance 30, which is disposed in the same position as the set transistor 24 in the fifth embodiment, is provided between a drain electrode of the time control transistor 22 and a set signal line ST. A selection signal of a selection signal line SL has its voltage change between −5 V and 8.5 V. A set signal of the set signal line ST has its voltage change between −5 V and 8.5 V. And a drive control signal of a drive control signal line VD has its voltage change between 0 V and 8.5 V.

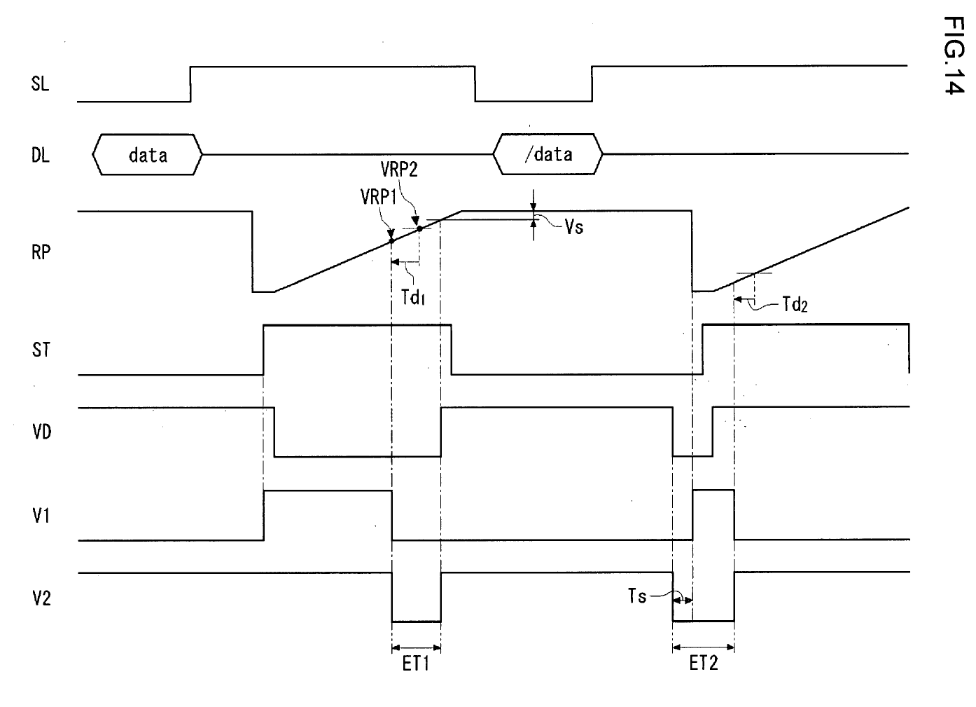

FIG. 14 is a timing chart showing a state change relationship among control signals inputted to a display apparatus 10 according to the sixth embodiment. Except for the change in a set signal, which differs from that of a set signal of the fifth embodiment, the basic changes and operations of other signals according to this sixth embodiment are the same as those of the fifth embodiment. The set signal of this sixth embodiment does not contain a pulse such as the set signal of the fifth embodiment does. To be more precise, in a first light emission, the set signal remains low until a ramp signal of a ramp signal line RP goes low, and the set signal goes high immediately after the ramp signal goes low and immediately before a drive control signal of a drive control signal line VD goes low. And this set signal goes low again immediately after the drive control signal goes high. In a second light emission, the set signal goes high immediately after the ramp signal goes low after the start of light emission.

As preparation for the first light emission, after a luminance signal indicating an emission start timing is inputted to a first node V0, the ramp signal of the ramp signal line RP goes low and the time control transistor 22 is turned off. Immediately after that, when the set signal goes high, the potential at a second node V1 is boosted via the set capacitance 30 and thus the potential at the second node V1 goes high. As a result, while the potential at a third node V2 remains high, the drive control transistor 20 is turned off. At this point, the drive control signal goes low.

Now the potential of the ramp signal increases gradually, and when the potential at the first node V0 reaches a value (VG+Vt), which is the sum of a time control potential VG and an operation threshold value Vt of the time control transistor 22, the time control transistor 22 turns on. With the time control transistor 22 turning on, the potential at the second node V1 drops, the drive control transistor 20 turns on, and the potential at the third node V2 also drops. As a result, the drive transistor 18 turns on and a drive current flows to the OLED 16, which in turn starts emitting light. Thereafter, as the drive control signal of the drive control signal line VD goes high with a predetermined timing, the potential at the third node V2 goes high and the drive transistor 18 is turned off. Thus a drive current is cut off from the OLED 16, which in turn stops the light emission of the OLED 16.

As preparation for the second light emission, a luminance signal indicating an emission stop timing is inputted to the first node V0, the drive control signal goes low, and the drive transistor 18 turns on. Then a drive current flows to the OLED 16, which in turn starts emitting light for the second time. Immediately after that, the ramp signal goes low and the time control transistor 22 is turned off. Now when the set signal goes high and the potential at the second node V1 is boosted via the set capacitance 30, the drive control transistor 20 is turned off while the potential at the third node V2 remains low. During this time, the drive control signal goes high.

Thereafter, as the ramp signal begins to rise again, the potential at the first node V0 also begins to rise. When the potential at the first node V0 reaches (VG+Vt), the time control transistor 22 turns on, the potential at the second node V1 drops and the drive control transistor 20 turns on. With the drive control transistor 20 turning on, the potential at the third node V2 rises, the drive transistor 18 turns off and the OLED 16 stops the emission of light.

As described hereinabove, the structure and operation in the sixth embodiment, similar to the fifth embodiment, are such that the sum of the first and the second emission time is constant irrespective of the variation in characteristics of the time control transistor 22. Thus luminance irregularity can be eliminated by canceling the effects of the operation threshold value of the time control transistor 22. Furthermore, the sixth embodiment features fewer transistors than the fifth embodiment. As a result, the aperture ratio can be raised, thus contributing the longer life of the OLED 16.

### Seventh Embodiment

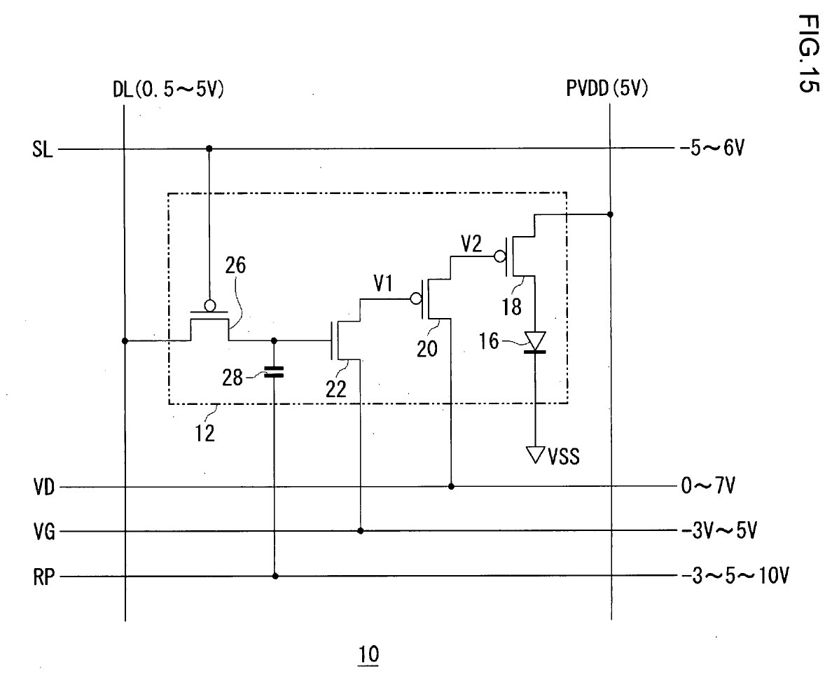

FIG. 15 illustrates a basic structure of a pixel included in a display apparatus according to a seventh embodiment of the present invention. In this seventh embodiment, the circuit configuration within a pixel differs partially from that of the fifth and sixth embodiments. And the following description will center on the differences from the fifth and sixth embodiments.

A pixel 12 includes an OLED 16, a drive transistor 18, a drive control transistor 20, a time control transistor 22, a write transistor 26 and a holding capacitance 28. The structure and arrangement of this seventh embodiment are the same as those of the fifth and the sixth embodiment, except for the set transistor 24 and the set signal line ST in the fifth embodiment and the set capacitance 30 and the set signal line ST in the sixth embodiment. That is, the set transistor 24 and the set signal line ST in the fifth embodiment are not provided in this seventh embodiment whereas the set capacitance 30 and the set signal line ST in the sixth embodiment are not provided in this seventh embodiment. A selection signal of a selection signal line SL has its voltage change between −5 V and 6 V. A drive control signal of a drive control signal line VD has its voltage change between 0 V and 7 V. A ramp signal of a ramp signal line RP has its voltage change between −3 V and 5 V and 10 V. And a time control potential VD changes between −3 V and 5 V.

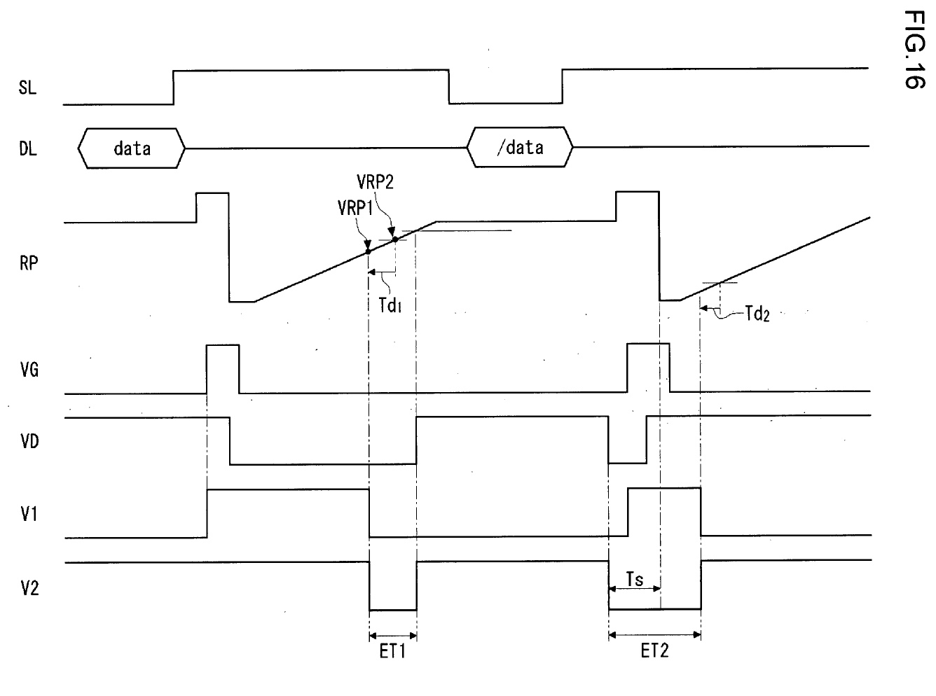

FIG. 16 is a timing chart showing a state change relationship among control signals inputted to a display apparatus 10 according to the seventh embodiment. In this seventh embodiment, the ramp signal not only has a linear part in its voltage change between −3 V and 5 V but also rises to an even higher level of 10 V. That is, in a first light emission control, after a luminance signal indicating an emission start timing is inputted to a first node V0 and the write transistor 26 is turned off, the ramp signal rises to a higher level, the potential at the first node V0 is boosted via the holding capacitance 28 and the time control transistor 22 is forcefully turned on. With the time control transistor 22 forcefully turning on, the potential at a second node V1 goes high, and the drive control transistor 20 is turned off, when the time control potential VG goes high. The operation in a first light emission control after the drive control transistor 20 is turned off is the same as in the fifth and the sixth embodiment.

In a second light emission control, after a second light emission is started by the OLED 16, the ramp signal rises to a higher level, the potential at the first node V0 is boosted via the holding capacitance 28, and the time control transistor 22 is forcefully turned on. With the time control transistor 22 forcefully turning on, the potential at the second node V1 goes high and the drive control transistor 20 is turned off, when the time control potential VG goes high. The operation in the second light emission control after the drive control transistor 20 is turned off is also the same as in the fifth and the sixth embodiment.

As described hereinabove, the structure and operation in this seventh embodiment, similar to the fifth and the sixth embodiment, are such that the sum of the first and the second emission time is constant irrespective of the variation in characteristics of the time control transistor 22. Thus luminance irregularity can be eliminated by canceling the effects of the operation threshold value of the time control transistor 22. Furthermore, the seventh embodiment features fewer transistors than the fifth embodiment, so that the aperture ratio can be raised and the life of the OLED 16 can be made longer.

### Eighth Embodiment

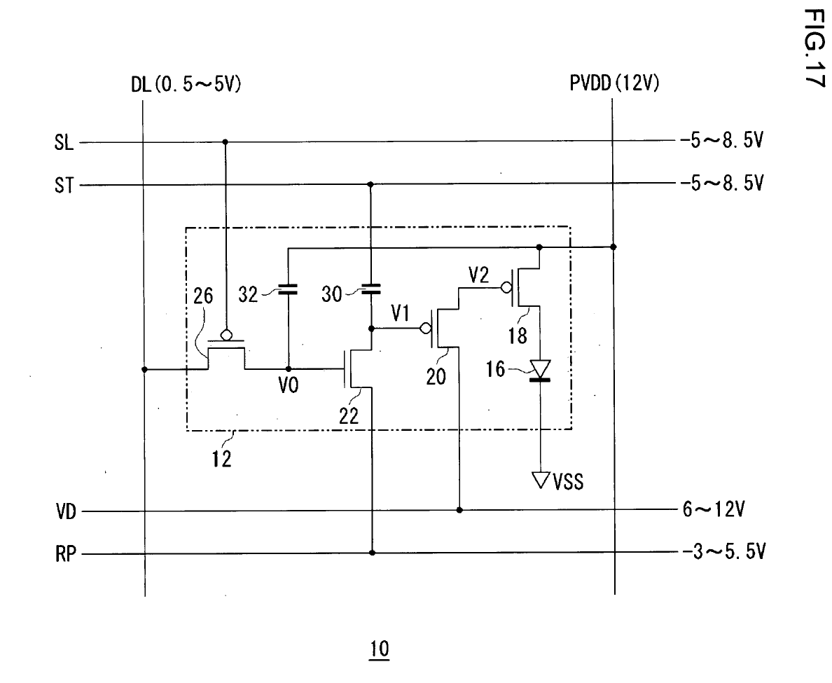

FIG. 17 illustrates a basic structure of a pixel included in a display apparatus according to an eighth embodiment of the present invention. In this eighth embodiment, the circuit configuration within a pixel differs partially from that of the fifth to seventh embodiments. And the following description will center on the differences from the fifth to seventh embodiments.

A pixel 12 includes an OLED 16, a drive transistor 18, a drive control transistor 20, a time control transistor 22, a write transistor 26, a set capacitance 30 and a holding capacitance 32. The set capacitance 30 of this eighth embodiment is of the same structure and position as that of the sixth embodiment. The set transistor 24 of the fifth embodiment is not provided in this eighth embodiment. Also, the holding capacitance 28 of the fifth embodiment is not provided in this eighth embodiment, but, in its place, a holding capacitance 32 is provided between a first node V0 and a power supply potential PVDD. A selection signal and a set signal, in the same way as in the sixth embodiment, have their respective voltages change between −5 V and 8.5 V. A drive control signal of a drive control signal line VD has its voltage change between 6 V and 12 V. With a source electrode of the time control transistor 22 connected to a ramp signal line RP, a ramp signal has its voltage change between −3 V and 5.5 V. A power supply potential PVDD is 12 V. The time control potential VG in the fifth to seventh embodiments is not provided in this eighth embodiment.

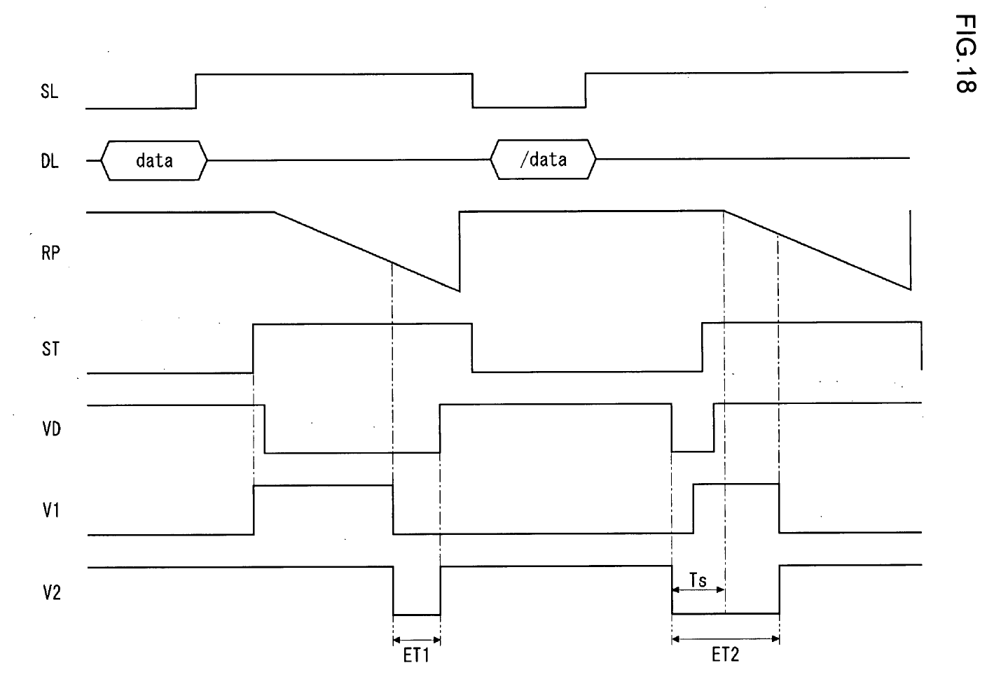

FIG. 18 is a timing chart showing a state change relationship among control signals inputted to a display apparatus 10 according to the eighth embodiment. In this eighth embodiment, a ramp signal has a linear part in its voltage change from high to low. That is, in a first light emission control, after a luminance signal indicating an emission start timing is set to a first node V0 and the write transistor 26 is turned off, a set signal goes high, the potential at a second node V1 is boosted via the set capacitance 30 and the drive control transistor 20 is turned off while the potential at a third node V2 remains high. In this condition, a drive control signal goes low.

Now the potential of the ramp signal begins to drop, and when it reaches a value, which results from subtracting an operation threshold value Vt of the time control transistor 22 from the potential of the luminance signal, the time control transistor 22 turns on. With the time control transistor 22 turning on, the potential at the second node V1 drops and the drive control transistor 20 turns on. With the drive control transistor 20 turning on, the potential at the third node V2 drops and the drive transistor 18 turns on. As a result, a drive current flows to the OLED 16, which in turn starts emitting light. Thereafter, as the drive control signal goes high with a predetermined timing and the potential at the third node V2 also goes high, the drive transistor 18 turns off. Thus a drive current is cut off from the OLED 16, which in turn stops the light emission of the OLED 16. Now the ramp signal goes high and the set signal goes low.

In a second light emission control, after a luminance signal indicating an emission stop timing is set to the first node V0 and the write transistor 26 is turned off, the drive control signal goes low, the drive transistor 18 turns on and a drive current flows to the OLED 16, which in turn starts emitting light. Then as the set signal goes high and the potential at the second node V1 goes high, the drive control transistor 20 is turned off with the potential at the third node V2 remaining low. In this condition, the drive control signal goes high. Now the potential of the ramp signal begins to drop gradually, and when it reaches a value, which results from subtracting the operation threshold value Vt of the time control transistor 22 from the potential of the luminance signal, the time control transistor 22 turns on, the potential at the second node V1 goes low and the drive control transistor 20 turns on. With the drive control transistor 20 turning on, the potential at the third node V2 goes high and the drive transistor 18 is turned off. As a result, a drive current is cut off from the OLED 16, which in turn stops the light emission of the OLED 16.

As described hereinabove, the structure and operation in this eighth embodiment, similar to the fifth to seventh embodiments, are such that the sum of the first and the second emission time is constant irrespective of the variation in characteristics of the time control transistor 22. Thus luminance irregularity can be eliminated by canceling the effects of the operation threshold value of the time control transistor 22. Furthermore, the eighth embodiment features fewer transistors than the fifth embodiment and a smaller holding capacitance 32 than the holding capacitance 28 in the fifth to seventh embodiments, so that the aperture ratio can be raised and the life of the OLED 16 can be made longer. Moreover, the eighth embodiment has less wiring than the other embodiments due to the absence of the time control potential VG, and this feature contributes to a further raising of the aperture ratio.

### Ninth Embodiment

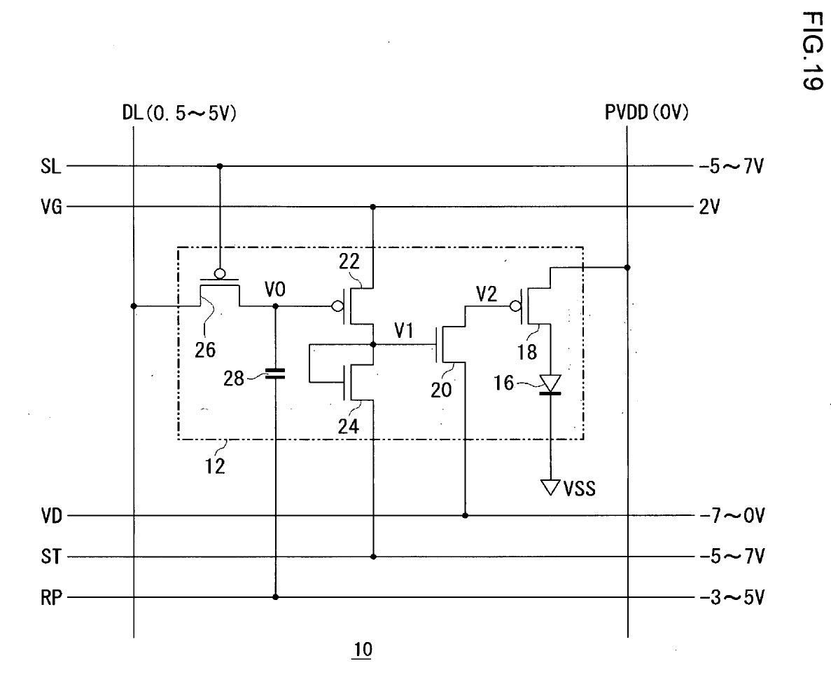

FIG. 19 illustrates a basic structure of a pixel included in a display apparatus according to a ninth embodiment of the present invention. In this ninth embodiment, the circuit configuration within a pixel differs partially from that of the fifth to eighth embodiments. The following description therefore will center on the differences from the fifth to eighth embodiments.

A pixel 12 includes an OLED 16, a drive transistor 18, a drive control transistor 20, a time control transistor 22, a set transistor 24, a write transistor 26 and a holding capacitance 28. The time control transistor 22, which is a p-channel MOS transistor in this ninth embodiment, differs from that of the fifth to eighth embodiments, which is an n-channel MOS transistor. On the other hand, the drive control transistor 20 and the set transistor 24, which are n-channel MOS transistors in this ninth embodiment, differ from those of the fifth to eighth embodiments, which are p-channel MOS transistors. The time control transistor 22 has a source electrode thereof connected to a source electrode of the set transistor 24 and a drain electrode thereof connected to a time control potential VG. The set transistor 24 has a drain electrode thereof connected to a set signal line ST and has the source electrode and drain electrode thereof short-circuited. A common source electrode for the time control transistor 22 and the set transistor 24 is connected to a gate electrode of the drive control transistor 20, and the node is called a second node V1.

A selection signal of a selection signal line SL has its voltage change between −5 V and 7 V. A set signal of a set signal line ST has its voltage change between −5 V and 7 V. A drive control signal of a drive control signal line VD has its voltage change between −7 V and 0 V. A time control potential VG is 2 V. A ramp signal of a ramp signal line RP has its voltage change between −3 V and 5 V. And a power supply potential PVDD is 0 V.

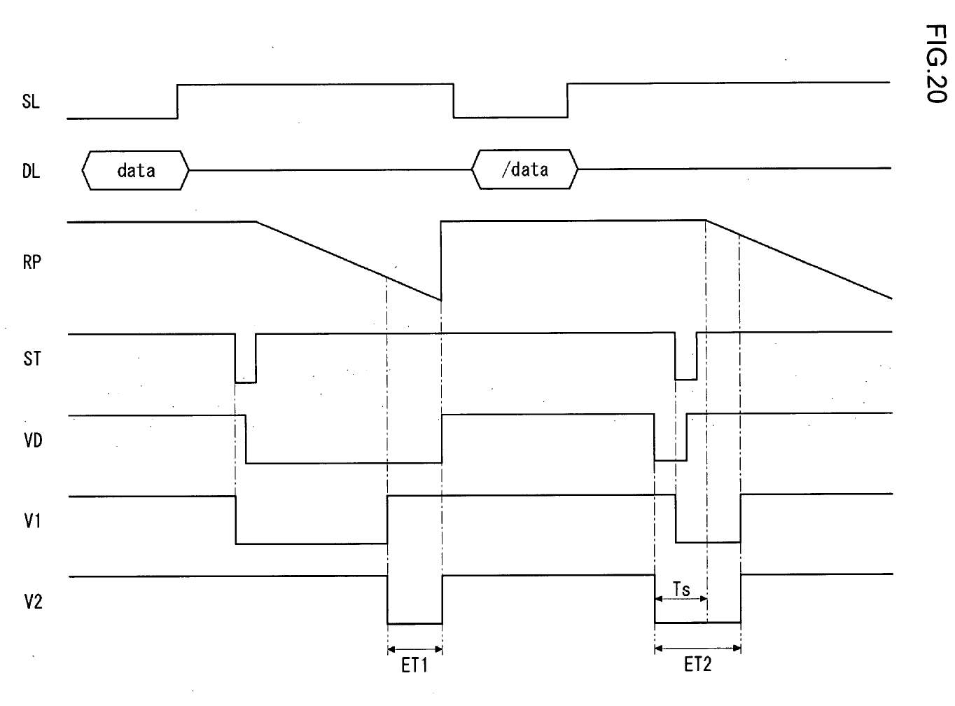

FIG. 20 is a timing chart showing a state change relationship among control signals inputted to a display apparatus 10 according to the ninth embodiment. In this ninth embodiment, the ramp signal has a linear part for its voltage change from high to low in the same way as in the eighth embodiment. Except for this point, the other signals change in the same way as in the fifth embodiment.

In a first light emission control, the control progresses in the same way as in the fifth embodiment until a luminance signal indicating an emission start timing is inputted to a first node V0 and held in the holding capacitance 28. After that, when a set signal goes low, the drive control transistor 20 is turned off with the potential at a third node V2 remaining high. In this condition, a drive control signal goes low. Now the potential of the ramp signal begins to drop from high, and when the potential at the first node V0 reaches a value (VG-Vt), which results from subtracting the operation threshold value Vt of the time control transistor 22 from the time control potential VG, the time control transistor 22 turns on. With the time control transistor 22 turning on, the potential at the second node V1 rises and the drive control transistor 20 turns on. With the drive control transistor 20 turning on, the potential at the third node V2 drops and the drive transistor 18 turns on. As a result, a drive current flows to the OLED 16, which in turn starts emitting light. Then as the drive control signal goes high with a predetermined timing, the OLED 16 stops the emission of light.

In a second light emission control, in the same way as in the fifth embodiment, after a luminance signal indicating an emission stop timing is inputted to the first node V0 and the drive control signal goes low, the OLED 16 starts emitting light. Then the set signal goes low and the drive control transistor 20 is turned off with the potential at the third node V2 remaining high. In this condition, the drive control signal line VD goes high. Now the potential of the ramp signal begins to drop, and when the potential at the first node V0 reaches a value (VG−Vt), which results from subtracting the operation threshold value Vt of the time control transistor 22 from the time control potential VG, the time control transistor 22 turns on. With the time control transistor 22 turning on, the potential at the second node V1 rises and the drive control transistor 20 turns on. With the drive control transistor 20 turning on, the potential at the third node V2 goes high and, hence, the drive transistor 18 is turned off. As a result, the OLED 16 stops the emission of light.

As described hereinabove, the structure and operation in this ninth embodiment, similar to the fifth to eighth embodiments, are such that the sum of the first and the second emission time is constant irrespective of the variation in characteristics of the time control transistor 22. Thus luminance irregularity can be eliminated by canceling the effects of the operation threshold value of the time control transistor 22.

The foregoing is merely illustrative of the principles of this ninth embodiment and various modifications can be made. For example, in place of the set transistor 24, a set capacitance, similar to one in the sixth embodiment, may be provided in the same position. The write transistor 26 may be an n-channel MOS transistor, and the set transistor 24 may be a p-channel MOS transistor. The structure may be so modified that the ramp signal is controlled in three levels of potential as in the seventh embodiment and the potential at the second node V1 is brought low by such a ramp signal via the holding capacitance 28 and the time control transistor 22. The structure may be so modified that, in the same way as in the eighth embodiment, one end of the holding capacitance 28 is connected to the power supply potential PVDD, instead of the ramp signal line RP, and at the same time the ramp signal line RP is connected to the time control transistor 22, instead of the time control potential VG.

### Tenth Embodiment

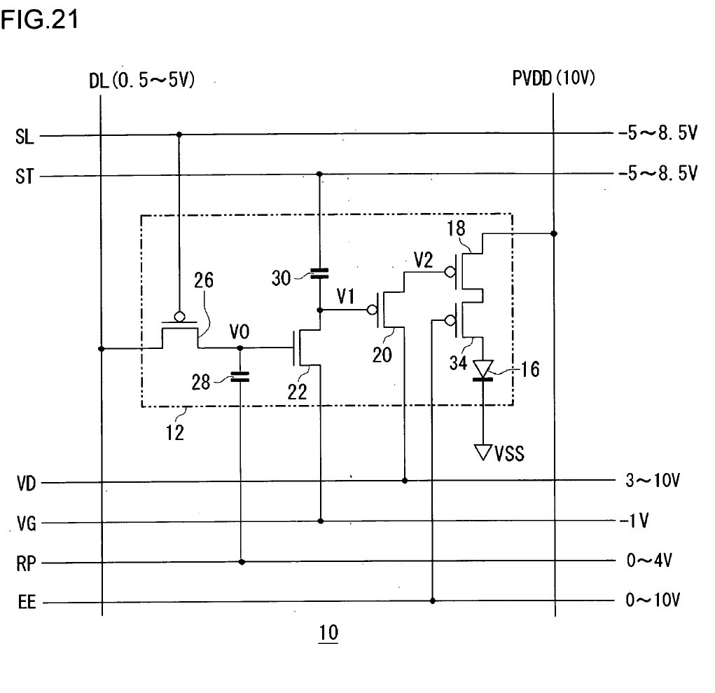

FIG. 21 illustrates a basic structure of a pixel included in a display apparatus according to a tenth embodiment of the present invention. In this tenth embodiment, the configuration and structure of the circuit within a pixel and of the signal lines differs partially from that of the fifth to ninth embodiments. The following description therefore will center on the differences from the fifth to ninth embodiments.

A pixel 12 includes an OLED 16, a drive transistor 18, a drive control transistor 20, a time control transistor 22, a write transistor 26, a holding capacitance 28, a set capacitance 30 and an emission control transistor 34. The structure and arrangement of a pixel 12, except for the emission control transistor 34, are the same as those of the pixel 12 in the sixth embodiment. The emission control transistor 34, which is a p-channel MOS transistor, has a source electrode thereof connected to a drain electrode of the drive transistor 18 and has a drain electrode thereof connected to an anode of the OLED 16. A gate electrode of the emission control transistor 34 is connected to an emission control signal line EE. Similar to the sixth embodiment, a selection signal and a set signal have their voltage change between −5 V and 8.5 V. A drive control signal of a drive control signal line VD has its voltage change between 3 V and 10 V. A ramp signal of a ramp signal line RP has its voltage change between 0 V and 4 V. An emission control signal of the emission control signal line EE has its voltage change between 0 V and 10 V. A time control potential VG is −1 V.

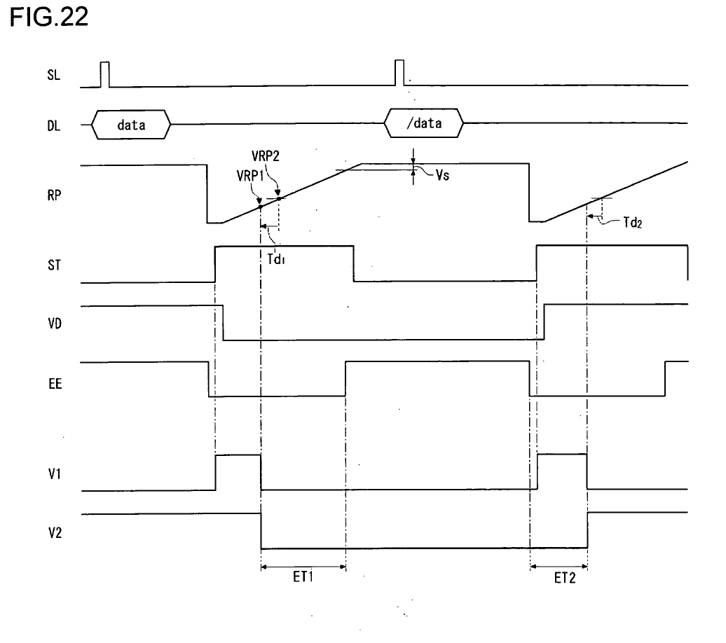

FIG. 22 is a timing chart showing a state change relationship among control signals inputted to a display apparatus 10 according to the tenth embodiment. The drive control signal of the drive control signal line VD in the fifth and ninth embodiment is a waveform containing asynchronous and short pulses. According to the tenth embodiment, part of timing with which to stop or start the emission of the OLED 16 is controlled by the emission control signal of the emission control signal line EE, thus further simplifying the drive control signal.

The basic part of state changes in the preparation of the first light emission is the same as the state changes of the sixth embodiment. More specifically, after a luminance signal indicating an emission start timing is inputted to a first node V0, a ramp signal of a ramp signal line RP goes low and the time control transistor 22 is turned off. Thereafter, a set signal goes high and a potential at a second node V1 goes high. As a result, the drive control, transistor 20 is turned off with the potential at a third node V2 remaining high. In this condition, a drive control signal goes low. At this time, the emission control signal of the emission control signal line EE according to the tenth embodiment is set to the low level, thereby turning an emission control transistor 34 on.

Similar to the sixth embodiment, when the potential of a ramp signal begins to rise and the potential at the first node V0 reaches (VG+Vt), which is the time control potential VG added with the operation threshold value Vt of the time control transistor 22, the time control transistor 22 is turned on and thereby the drive control transistor 20 and the drive transistor 18 are turned on in sequence. As described above, since the emission control transistor 34 is on, the drive current flows to the OLED 16 and the OLED starts emitting the light. Thereafter, differing from the sixth embodiment, the drive control signal of the drive control signal line VD remains low and with a predetermined timing the emission control signal of the emission control signal line EE becomes high and then the emission control transistor 34 is turned off. As a result, the drive current to the OLED 16 is cut off and the OLED 16 stops emitting light.

In preparation for a second light emission, a luminance signal indicating an emission stop timing is inputted to the first node V0. In the tenth embodiment the drive control signal and the potential at the second node V1 are low, and the potential at the third node V2 remains low since the first light emission. Thus the drive transistor 18 has been turned on. Now when the emission control signal of the emission control signal line EE goes low, the emission control transistor 34 is turned on and the drive current is supplied to the OLED 16, thus starting the second emission of the OLED 16. On the other hand, the ramp signal goes low and the time control transistor 22 is turned off. After that, the set signal goes high and the potential at the second node V1 goes high similarly to the sixth embodiment. As a result, the drive control transistor 20 is turned off with the potential at the third node V2 remaining low. Thereafter, the drive control signal goes high.

Then, similar to the sixth embodiment, the ramp signal rises again. Thus, the time control transistor 22 is turned on when the potential at the first node V0 reaches (VG+Vt). And the potential at the second node V1 drops and the drive control transistor 20 is turned on. As a result, the potential at the third node V2 rises and the drive transistor 18 is turned off, so that the OLED 16 stops the emission of light.

As described hereinabove, the structure and operation in this tenth embodiment, similar to the fifth to ninth embodiments, are such that the sum of the first and the second emission time is constant irrespective of the variation in characteristics of the time control transistor 22. Thus luminance irregularity can be eliminated by canceling the effects of the operation threshold value of the time control transistor 22. Furthermore, the one-time emission stoppage and the two-time emission starts are controlled by the emission control signal line EE and the emission control transistor 34. Thus, the input waveform does not contain asynchronous and short pulses, so that the same advantageous operations and effects as with the fifth to ninth embodiments are achieved and the burden on the clock generation is small.

The foregoing is merely illustrative of the principles of this tenth embodiment and various modifications can be made. For example, the emission control transistor 34 may be an n-channel MOS transistor, and the emission control signal of the emission control signal line EE may be an inverted waveform. A structure may be such that a set transistor, similar to the fifth embodiment, may be provided in place of the set capacitance 30. The structure may be so modified that the ramp signal is controlled in three levels of potential as in the seventh embodiment and the potential at the second node V1 is brought low by such a ramp signal via the holding capacitance 28 and the time control transistor 22. The structure may be so modified that, in the same way as in the eighth embodiment, one end of the holding capacitance 28 is connected to the power supply potential PVDD, instead of the ramp signal line RP, and at the same time the ramp signal line RP is connected to the time control transistor 22, instead of the time control potential VG. The time control potential VG may be a fixed value that lies in the range between −1 V and 1 V (both inclusive).

### Eleventh Embodiment

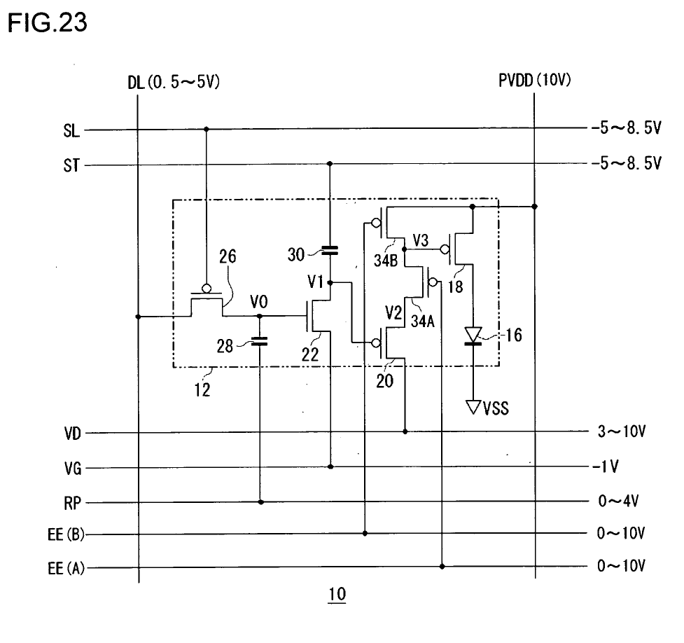

FIG. 23 illustrates a basic structure of a pixel included in a display apparatus according to an eleventh embodiment of the present invention. In this eleventh embodiment, the configuration and structure of the circuit within a pixel and of the signal lines differs partially from that of the fifth to tenth embodiments. The following description therefore will center on the differences from the fifth to tenth embodiments.

A pixel 12 includes an OLED 16, a drive transistor 18, a drive control transistor 20, a time control transistor 22, a write transistor 26, a holding capacitance 28, a set capacitance 30, a first emission control transistor 34A and a second emission control transistor 34B. The structure and arrangement of a pixel 12, except for the first and second emission control transistors 34A and 34B and connection wires therefor, are the same as those of the pixel 12 in the sixth embodiment. The first emission control transistor 34A and the second emission control transistor 34B are both p-channel MOS transistors.

A source electrode (drain electrode) of the first emission control transistor 34A is connected to a source electrode (drain electrode) of the drive control transistor 20, and the drain electrode (source electrode) thereof is connected to a drain electrode of the second emission control transistor 34B. A gate electrode of the first emission control transistor 34A is connected to a first emission control signal line EE(A). The source electrode of the second emission control transistor 34B, together with the drive transistor 18 which is connected in parallel with the second emission control transistor 34B, is connected to a power supply potential PVDD whereas a gate electrode of the second emission control transistor 34B is connected to a second emission control signal line EE (B). A gate electrode of the drive transistor 18 according to the eleventh embodiment is connected to the source electrode (drain electrode) of the first emission control transistor 34A and the drain electrode of the second emission control transistor 34B. Similar to the sixth embodiment, a selection signal and a set signal have their voltage change between −5 V and 8.5 V. Similar to the tenth embodiment, a drive control signal and a ramp signal have their voltage change between 3 V and 10 V and between 0 V and 4 V, respectively. Both an emission control signal of the first emission control signal line EE(A) and an emission control signal of the second emission control signal line EE(B) have their voltage change between 0.0 V and 10 V.

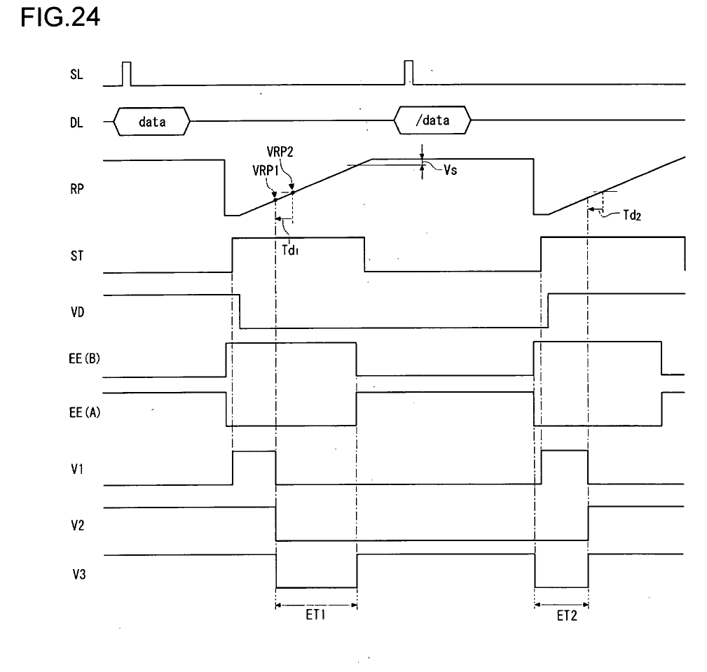

FIG. 24 is a timing chart showing a state change relationship among control signals inputted to a display apparatus 10 according to the eleventh embodiment. Similar to the tenth embodiment, the asynchronous and short pulses are not contained in the drive control signal of a drive control signal line VD in the eleventh embodiment. And part of timing with which to stop or start the emission of the OLED 16 is controlled by the emission control signals of the first emission control signal line EE(A) and the second emission control signal line EE(B), thus further simplifying the drive control signal.

The basic part of state changes in the preparation for a first light emission is the same as the state changes of the sixth and the tenth embodiment. More precisely, after a luminance signal indicating an emission start timing is inputted to a first node V0, a ramp signal of a ramp signal line RP goes low and the time control transistor 22 turns off. Thereafter, a set signal goes high and a potential at a second node V1 goes high. As a result, the drive control transistor 20 is turned off while a third node V3, which is a common source electrode to the drive transistor 20 and the first emission control transistor 34A, remains high. In this condition, the drive control signal goes low. In this eleventh embodiment, on the other hand, the emission control signal of the first emission control signal line EE(A) is set to the low level and the emission control signal of the second emission control signal line EE(B) is set to the high level. Thereby, the first emission control transistor 34A turns on and the second emission control transistor 34B turns off.

When the potential of a ramp signal begins to rise and the potential at the first node V0 reaches (VG+Vt), which is the time control potential VG added with the operation threshold value Vt of the time control transistor 22, the time control transistor 22 is turned on. With this time control transistor 22 turning on, the drive control transistor 20 is turned on and the potential at the third node V2 goes low. As described above, since the emission control signal of the first emission control signal line EE(A) is low, the first emission control transistor 34A is on. Hence, a potential of a fourth node V3, which is both the source electrode of the first emission control transistor 34A and the drain electrode of the second emission control transistor 34B, goes low. As a result, the drive transistor 18 is turned on and a drive current is supplied to the OLED 16, which in turn starts emitting light.

Then, with the drive control signal of the drive control signal line VD remaining low, the emission control signal of the first emission control signal line EE(A) goes high with a predetermined timing, and the first emission control transistor 34A is turned off. At the same time, the emission control signal of the second emission control signal line EE(B) goes low and the second emission control transistor 34B is turned on. As a result, since the potential at the fourth node V3 goes high due to the power supply potential PVDD, the drive transistor 18 is turned off and the drive current to the OLED 16 is cut off, which in turn stops the light emission of the OLED 16.

The preparation for the second light emission is, similar to the tenth embodiment, such that a luminance signal indicating an emission stop timing is inputted to the first node V0. Similar to the tenth embodiment, since the drive control signal and the potential at the second node V1 are low, the potential at the third node V2 remains low since the first light emission. Now, in the eleventh embodiment, the emission control signal of the second emission control signal line EE(B) goes high and the second emission control transistor 34B is turned off; at the same time the emission control signal of the first emission control signal line EE(A) goes low and the first emission control transistor 34A is turned on. Then the fourth node V3 goes low and the drive transistor 18 is turned on, thus starting the emission of the OLED 16.

Thereafter, similar to the tenth embodiment, the ramp signal goes low, which turns the time control transistor 22 off. The set signal goes high and therefore the potential at the first node V1 goes high, which turns the drive control transistor 20 off. Then the drive control signal goes high. And when the ramp signal rises and the potential at the first node V0 reaches (VG+Vt), the time control transistor 22 is turned on, the potential at the second node V1 drops and the drive control transistor 20 is turned on. This raises the potential of the third node V2. Since the first emission control transistor 34A is in the state of being on, the potential at the fourth node V3 also rises and the drive transistor 18 is turned off. Thereby, the OLED 16 stops emitting light.

As described hereinabove, the structure and operation in this eleventh embodiment, similar to the fifth to tenth embodiments, are such that the sum of the first and the second emission time remains constant independently of the variation in characteristics of the time control transistor 22. Thus luminance irregularity can be eliminated by canceling the effects of the operation threshold value of the time control transistor 22. Furthermore, similar to the tenth embodiment, the input waveform does not contain asynchronous and short pulses, so that the same advantageous operations and effects as with the fifth to tenth embodiments are achieved and the burden on the clock generation is small. Furthermore, since transistors for controlling the light emission are arranged in a position previous to the drive transistor 18, the drive transistor 18 is the only transistor disposed between the power supply potential PVDD and the OLED 16. This arrangement proves more efficient, in terms of power supply, than a case where the transistors are disposed in series with the drive transistor 18.

The first emission control transistor 34A and the second emission control transistor 34B may be n-channel MOS transistors and the emission control signals of the first emission control signal line EE(A) and the second emission control signal line EE(B) may be inverted waveforms. A structure may be such that a set transistor, similar to the fifth embodiment, may be provided in place of the set capacitance 30. The structure may be so modified that the ramp signal is controlled in three levels of potential as in the seventh embodiment and the potential at the second node V1 is brought low by such a ramp signal via the holding capacitance 28 and the time control transistor 22. The structure may be so modified that, in the same way as in the eighth embodiment, one end of the holding capacitance 28 is connected to the power supply potential PVDD, instead of the ramp signal line RP, and at the same time the ramp signal line RP is connected to the time control transistor 22, instead of the time control potential VG. The time control potential VG may be a fixed value that lies in the range between −1 V and 1 V (both inclusive).

The present invention has been described based on the embodiments which are only exemplary. It is therefore understood by those skilled in the art that there exist other various modifications to the combination of each component and process described above and that such modifications are also within the scope of the present invention. Hereinbelow, some modifications to the fifth to eleventh embodiments will be described.

Each transistor provided as a p-channel MOS transistor in each of the embodiments may be structured by an n-channel MOS transistor, or each transistor provided as an n-channel MOS transistor in each of the embodiments may be structured by a p-channel MOS transistor. However, the type of channel (n- or p-channel) of the time control transistor 22 is always in the opposite relation to that of the drive control transistor 20 in the time control transistor 22 and the drive control transistor 20. That is, if the time control transistor 22 is an n-channel MOS transistor, then the drive control transistor 20 is a p-channel MOS transistor. And if the time control transistor 22 is a p-channel MOS transistor, then the drive control transistor 20 is an n-channel MOS transistor. This is because the drive control transistor 20 is to be forcefully turned on when the time control transistor 22 turns on.

In the present embodiments, the emission start timing is controlled in the first emission period, and the emission stop timing is controlled in the second emission period. However, the sequence of the emission start timing and the emission stop timing is not limited thereto. In this modification, the emission stop timing may be controlled in the first emission period, and the emission start timing may be controlled in the second emission period. A plurality of such emission periods may not be in continuous sequences.

In the present embodiments, the organic EL element is used in the description above as a light emitting element included in a display apparatus. The same operations and advantageous effects as described in the above present embodiments can be achieved if the display apparatus is constituted by other light emitting elements such as an inorganic EL element.

Although the present invention has been described by way of exemplary embodiments and modifications, it should be understood that many other changes and substitutions may further be made by those skilled in the art without departing from the scope of the present invention which is defined by the appended claims.

1. A display apparatus including a plurality of pixels arranged in a matrix, each of the plurality of pixels including:
an optical element of current-driven type;
a drive circuit of non-complementing type which drives said optical element based on a luminance signal and self-corrects a drive operation thereof;
a correction circuit which controls on and off of the self-correction of said drive circuit; and
a holding circuit which holds the luminance signal used in the drive operation,
wherein said drive circuit generates a luminance signal which is corrected based on a predetermined signal delivered temporarily and an operation threshold value of said drive circuit, and self-corrects the drive operation by driving said optical element based on the corrected luminance signal.

2. A display apparatus according to claim 1, each of the plurality of pixels further including a control circuit which controls drive of said optical element by said drive circuit, by gradually changing voltage of the luminance signal held in said holding circuit,
wherein said drive circuit self-corrects operation timing of said drive circuit.

3. A display apparatus according to claim 1, wherein said drive circuit performs self-correction by using an uncorrected luminance signal delivered temporarily as a predetermined signal.

4. A display apparatus according to claim 1, each of the plurality of pixels further including a power supply circuit which shuts off said drive circuit from a power supply line during a period at which the self-correction is being performed.

5. A display apparatus including a plurality of pixels arranged in a matrix, each of the plurality of pixels including:
an optical element of current-driven type;
a drive circuit which drives said optical element based on a luminance signal and self-corrects a drive operation thereof;
a power supply circuit, connected with said drive circuit, which controls power supply to said optical element via said drive circuit;
a write circuit, connected with said drive circuit, which controls input of the luminance signal to the pixel;
a correction circuit which connects and shuts off a path through which a signal that has flowed to said drive circuit is inputted to said drive circuit for performing self-correction;
a holding capacitance which holds a signal inputted to said drive circuit;
a control circuit which controls drive of said optical element by said drive circuit, by gradually changing voltage of the signal held by said holding capacitance; and
a reset circuit which connects and shuts off a path of drive current to said optical element,
wherein said drive circuit generates a luminance signal which is corrected based on a luminance signal delivered temporarily through said write circuit and an operation threshold value of said drive circuit, and self-corrects the drive operation by driving said optical element based on the thus corrected luminance signal,
wherein said power supply circuit shuts off power to said optical element via said drive circuit during a period at which the self-correction is being performed, and
wherein said reset circuit shuts off the path of drive current to said optical element during a period at which the self-correction is being performed.

6. A display apparatus controlling method, comprising:
delivering a predetermined signal to a drive circuit of non-complementing type which drives an optical element of current-driven type;
generating a luminance signal by correcting the predetermined signal flowing through the drive circuit with an operation threshold value of the drive circuit;
setting the corrected luminance signal in the drive circuit and holding the thus set corrected luminance signal;
shutting off flow of the predetermined signal to the drive circuit; and
supplying drive current to the optical element by gradually changing voltage of the luminance signal held in said setting and holding.

7. A display apparatus of active matrix type, including:
a plurality of pixels arranged in a matrix; and
a data control circuit which inputs a luminance signal to each of the plurality of pixels so that one frame is displayed a plurality of times in different scanning directions.

8. A display apparatus of active matrix type, comprising:
a plurality of pixels arranged in a matrix;
a selection control circuit which selects a pixel line to which a luminance signal is to be inputted among the plurality of pixels; and
a data control circuit which sequentially inputs the luminance signal for each pixel contained in the pixel line selected by said selection control circuit,
wherein said data control circuit is such that after a luminance signal for one frame is inputted to each pixel, the same luminance signal for one frame is again inputted to the each pixel in a reversed scanning direction, in order for the luminance signal for one frame to be inputted a plurality of times for the each pixel.

9. A display apparatus, including:
a plurality of pixels arranged in a matrix;
a selection control circuit which selects a pixel line to which a luminance signal is to be inputted among the plurality of pixels; and
a data control circuit which sequentially inputs the luminance signal for each pixel contained in the pixel line selected by said selection control circuit,
each of the plurality of pixels including:
an optical element of current-driven type;
a drive circuit which drives the optical element based on a luminance signal which has been corrected according to an operating characteristic; and
a write circuit which controls write of the luminance signal,
wherein said data control circuit is such that after a luminance signal for one frame is inputted to each pixel, the same luminance signal for one frame is again inputted to the each pixel in a reversed scanning direction, in order for the luminance signal for one frame to be inputted a plurality of times for the each pixel.

10. A display apparatus according to claim 7, wherein said data control circuit inputs an equal luminance signal to each pixel respectively in a plurality of subframe periods which are obtained by dividing one frame period.

11. A display apparatus according to claim 8, wherein said data control circuit reverses the scanning direction for the each pixel line selected.

12. A display apparatus controlling method, including:
first selecting sequentially a pixel line, to which a luminance signal is to be inputted, among a plurality of pixels arranged in a matrix;
inputting sequentially a luminance signal of one frame in a predetermined scanning direction for each pixel contained in the pixel line selected by said first selecting, every time the pixel line is selected in the first selecting;
correcting the inputted luminance signal based on an operating characteristic of a drive circuit included in the pixel;
second selecting sequentially the pixel line from the beginning, after completing said first selecting for all pixel lines contained in the plurality of pixels;
inputting sequentially the same luminance signal as said luminance signal of one frame in a scanning direction opposite to the predetermined scanning direction for each pixel contained in the pixel line selected by said second selecting, every time the pixel line is selected in the second selecting; and
correcting the inputted luminance signal based on an operating characteristic of a drive circuit included in the pixel.

13. A display apparatus using a time gradation system, the apparatus comprising:
an optical element of current-driven type;
a drive circuit which drives said optical element; and
a time control circuit which controls drive timing by said drive circuit according to a luminance signal inputted,
wherein said time control circuit controls emission start timing according to the luminance signal in a control of a first emission period which is any emission period among a plurality of emission periods for one luminance signal, and controls emission stop timing according to the luminance signal in a control of a second emission period which is any emission period different from the first emission period thereamong.

14. A display apparatus according to claim 13, wherein a difference caused in the emission start timing according to the luminance signal in the control of a first emission period and based on variation in an operation threshold of said time control circuit is cancelled by a difference caused in the emission stop timing according to the luminance signal in the control of a second emission period and based on variation in an operation threshold of said time control circuit.

15. A display apparatus according to claim 13, further comprising a drive control circuit which turns said drive circuit on in the first emission period when said time control circuit is turned on and which turns said drive circuit off in the second emission period when said time control circuit is turned on.

16. A display apparatus according to claim 13, wherein said time control circuit controls, in the control of the first emission period, the emission start timing by said drive circuit, by gradually changing voltage of a luminance signal indicative of the emission start timing whereas said time control circuit controls, in the control of the second emission period, the emission stop timing by said drive circuit, by gradually changing voltage of a luminance signal indicative of the emission stop timing.

17. A display apparatus according to claim 13, wherein said time control circuit is structured by a transistor and wherein said time control circuit controls, in the control of the first emission period, the emission start timing by said drive circuit, by gradually changing one of source voltage and drain voltage of the transistor whereas said time control circuit controls, in the control of the second emission period, the emission stop timing by said drive circuit, by gradually changing one of source voltage and drain voltage of the transistor.

18. A display apparatus, comprising:
a time control transistor which controls drive timing of an optical element according to a luminance signal inputted; and
a circuit which gradually changes one of source voltage and drain voltage of said time control transistor,
wherein said time control transistor controls emission start timing of the optical element in a control of a first emission period which is any emission period among a plurality of emission periods for one luminance signal, by gradually changing one of the source voltage and drain voltage thereof whereas said time control transistor controls emission stop timing of the optical element in a control of a second emission period which is any emission period different from the first emission period thereamong, by gradually changing one of the source voltage and drain voltage thereof.

19. A display apparatus controlling method, including:
inputting a luminance signal indicative of emission start timing of an optical element in a control of a first emission period which is any emission period among a plurality of emission periods for one luminance signal;
changing gradually voltage of the luminance signal indicative of the emission start timing;
turning a drive circuit on and starting emission of the optical element when a time control circuit which controls drive timing by the drive circuit is turned on by said changing gradually voltage of the luminance signal;
stopping the emission of the optical element with a predetermined timing;
inputting a luminance signal indicative of emission stop timing of the optical element in a control of a second emission period which is any emission period different from the first emission period among the plurality of emission periods;
starting emission of the optical element with a predetermined timing;
changing gradually voltage of the luminance signal indicative of the emission stop timing; and
turning the drive circuit off and stopping the emission of the optical element when the time control circuit is turned on by said changing gradually voltage of the luminance signal.
